(19) United States
(12) Patent Application Publication
(10) Pub. No.: US 2026/0230250 A1
(43) Pub. Date: Aug. 6, 2026

(54) PRE-COMPENSATION OF UPLINK NON-TERRESTRIAL NETWORK TRANSMISSION BASED ON ORTHOGONAL COVER CODE CONFIGURATION

(71) Applicant: QUALCOMM Incorporated, San Diego, CA (US)

(72) Inventors: Syed Hashim Ali SHAH, Littleton, MA (US); Ayan SENGUPTA, Mountain View, CA (US); Alberto RICO ALVARINO, San Diego, CA (US)

(21) Appl. No.: 19/391,958

(22) Filed: Nov. 17, 2025

Related U.S. Application Data
(60) Provisional application No. 63/753,337, filed on Feb. 3, 2025.

(51) Int. Cl. H04L 5/00

(52) U.S. Cl. CPC H04L 5/0044; H04L 5/0007

(57) ABSTRACT

Systems and techniques are provided for wireless communications. For example, a first network entity can receive, from a second network entity, information indicative of an orthogonal cover coding (OCC) configuration, where the OCC configuration corresponds to an uplink transmission from the first network entity to the second network entity. The first network entity can determine, based on the OCC configuration, pre-compensation information for the uplink transmission, the pre-compensation information corresponding to the first network entity and the second network entity. The first network entity can transmit the uplink transmission to the second network entity according to the pre-compensation information, wherein the uplink transmission is multiplexed according to the OCC configuration.

### CROSS-REFERENCE TO RELATED APPLICATIONS

This application claims the benefit of U.S. Provisional Application No. 63/753,337, filed Feb. 3, 2025, which is hereby incorporated by reference, in its entirety and for all purposes.

### INTRODUCTION

Aspects of the present disclosure generally relate to wireless communication. In some implementations, examples are described for implementing an uplink pre-compensation segment length based on an orthogonal cover code (OCC) configuration associated with multiplexing transmissions from multiple user equipments (UEs) to a non-terrestrial network (NTN).

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. The network entity includes a processing system, where the processing system is configured to: receive, from a second network entity, information indicative of an orthogonal cover coding (OCC) configuration, wherein the OCC configuration corresponds to an uplink transmission from the first network entity to the second network entity; determine, based on the OCC configuration, pre-compensation information for the uplink transmission, the pre-compensation information corresponding to the network entity and the second network entity; and transmit the uplink transmission to the second network entity according to the pre-compensation information, wherein the uplink transmission is multiplexed according to the OCC configuration.

In another example, a method for wireless communication is provided, the method including: receiving, from a second network entity, information indicative of an orthogonal cover coding (OCC) configuration, wherein the OCC configuration corresponds to an uplink transmission from a first network entity to the second network entity; determining, based on the OCC configuration, pre-compensation information for the uplink transmission, the pre-compensation information corresponding to the first network entity and the second network entity; and transmitting the uplink transmission to the second network entity according to the pre-compensation information, wherein the uplink transmission is multiplexed according to the OCC configuration.

In another example, a non-transitory computer-readable storage medium is provided comprising instructions stored thereon which, when executed by at least one processor, causes the at least one processor to: receive, from a second network entity, information indicative of an orthogonal cover coding (OCC) configuration, wherein the OCC configuration corresponds to an uplink transmission from a first network entity to the second network entity; determine, based on the OCC configuration, pre-compensation information for the uplink transmission, the pre-compensation information corresponding to the first network entity and the second network entity; and transmit the uplink transmission to the second network entity according to the pre-compensation information, wherein the uplink transmission is multiplexed according to the OCC configuration.

In another example, an apparatus is provided for wireless communication. The apparatus includes: means for receiving, from a second network entity, information indicative of an orthogonal cover coding (OCC) configuration, wherein the OCC configuration corresponds to an uplink transmission from a first network entity to the second network entity; means for determining, based on the OCC configuration, pre-compensation information for the uplink transmission, the pre-compensation information corresponding to the first network entity and the second network entity; and means for transmitting the uplink transmission to the second network entity according to the pre-compensation information, wherein the uplink transmission is multiplexed according to the OCC configuration

According to another illustrative example, a network entity for wireless communication is provided. The network entity includes at a processing system, where the processing system is configured to: transmit, to a user equipment (UE), information indicative of an orthogonal cover coding (OCC) configuration, wherein an uplink transmission from the UE to the network entity is multiplexed with a set of respective uplink transmissions to the network entity according to the OCC configuration; transmit, to the UE, pre-compensation information for the uplink transmission, the pre-compensation information based on the OCC configuration, and wherein the pre-compensation information corresponds to the network entity and the UE; and receive, from a set of UEs including the UE, a set of multiplexed uplink transmissions including the uplink transmission from the UE and the set of respective uplink transmissions multiplexed according to the OCC configuration, wherein the uplink transmission from the UE is received according to the pre-compensation information.

In another example, a method for wireless communication is provided, the method including: transmitting, to a user equipment (UE), information indicative of an orthogonal cover coding (OCC) configuration, wherein an uplink transmission from the UE to a network entity is multiplexed with a set of respective uplink transmissions to the network entity according to the OCC configuration; transmitting, to the UE, pre-compensation information for the uplink transmission, the pre-compensation information based on the OCC configuration, and wherein the pre-compensation information corresponds to the network entity and the UE; and receiving, from a set of UEs including the UE, a set of multiplexed uplink transmissions including the uplink transmission from the UE and the set of respective uplink transmissions multiplexed according to the OCC configuration, wherein the uplink transmission from the UE is received according to the pre-compensation information.

In another example, a non-transitory computer-readable storage medium is provided comprising instructions stored thereon which, when executed by at least one processor, causes the at least one processor to: transmit, to a user equipment (UE), information indicative of an orthogonal cover coding (OCC) configuration, wherein an uplink transmission from the UE to a network entity is multiplexed with a set of respective uplink transmissions to the network entity according to the OCC configuration; transmit, to the UE, pre-compensation information for the uplink transmission, the pre-compensation information based on the OCC configuration, and wherein the pre-compensation information corresponds to the network entity and the UE; and receive, from a set of UEs including the UE, a set of multiplexed uplink transmissions including the uplink transmission from the UE and the set of respective uplink transmissions multiplexed according to the OCC configuration, wherein the uplink transmission from the UE is received according to the pre-compensation information.

In another example, an apparatus is provided for wireless communication. The apparatus includes: means for transmitting, to a user equipment (UE), information indicative of an orthogonal cover coding (OCC) configuration, wherein an uplink transmission from the UE to a network entity is multiplexed with a set of respective uplink transmissions to the network entity according to the OCC configuration; means for transmitting, to the UE, pre-compensation information for the uplink transmission, the pre-compensation information based on the OCC configuration, and wherein the pre-compensation information corresponds to the network entity and the UE; and means for receiving, from a set of UEs including the UE, a set of multiplexed uplink transmissions including the uplink transmission from the UE and the set of respective uplink transmissions multiplexed according to the OCC configuration, wherein the uplink transmission from the UE is received according to the pre-compensation information.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 illustrates an example of an encoding configuration that supports orthogonal cover coding (OCC) for multiplexing transmissions by multiple UEs, in accordance with some examples;

FIG. 7 is a transmission timing diagram illustrating a first example of segmented pre-compensation for non-terrestrial network (NTN) uplink (UL) transmissions by multiple UEs configured for OCC multiplexing using a first multiplexing factor, in accordance with some examples;

FIG. 8 is a transmission timing diagram illustrating a second example of segmented pre-compensation for NTN UL transmissions by multiple UEs configured for OCC multiplexing using a second multiplexing factor, in accordance with some examples;

FIG. 9 is a transmission timing diagram illustrating an example of segmented pre-compensation for NTN UL transmissions by multiple UEs configured for OCC multiplexing using a pre-compensation segment length different from a slot length, in accordance with some examples;

FIG. 10 is a flow diagram illustrating an example of a process for wireless communication, in accordance with some examples;

FIG. 11 is a flow diagram illustrating another example of a process for wireless communication, in accordance with some examples; and

FIG. 12 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In some wireless communications systems (e.g., such as in a narrowband Internet-of-Things (NB-IoT) system), uplink communication by a UE may include the UE transmitting multiple coded copies of data. For example, the uplink communication by the UE can be performed according to a multiple access scheme to provide multiplexed uplink transmissions from UEs based on repetition of data. In some examples, the repetitions may include uplink hybrid automatic repeat request (HARQ) redundancy versions (RVs). To increase uplink capacity of a network, multiple UEs may simultaneously access same and/or overlapping time-frequency resources by using a non-orthogonal multiple access (NOMA) scheme, where data from the multiple UEs is identified at a network entity of the network. In NOMA schemes, the simultaneous transmissions from the multiple UEs may cause uplink interference at the network entity. Identifying the data at the network entity as coming from particular UEs may be complex and time consuming. For example, identifying data from respective UEs may correspond to configuring the UEs to implement complex and robust scrambling schemes for receiver-side identification of the respective UEs, and/or can correspond to implementing relatively complex receiver (e.g., network entity, base station, gNB, etc.) design.

In some cases, transmitting UEs may use an orthogonal cover code (OCC) to perform orthogonal M-order UE multiplexing without requiring robust scrambling and/or complex receiver design at the network entity. When the total number of repetitions associated with the OCC coding is more than 2 M, the UEs can apply the M factor cover coding without increasing the of time-frequency resources used for the uplink transmissions. Uplink capacity (e.g., the quantity of UEs that can be scheduled in a particular time-frequency resource, with little to no interference among the UEs) is increased from the network perspective.

A network entity may transmit control signaling to a UE that indicates a multiplexing order (e.g., also referred to herein as an “OCC length” and/or an “OCC factor”), a repetition configuration, and an orthogonal cover coding configuration to apply to an uplink grant. The multiplexing order, M, indicates the quantity (e.g., number) of uplink transmissions from different UEs that can be multiplexed over the same time-frequency resources. For example, the multiplexing order M can indicate a threshold number of UEs for the multiplexing (e.g., the number of UEs is less than or equal to M). The network entity may indicate the repetition configuration and the orthogonal cover coding configuration to up to M UEs that will transmit multiplexed uplink transmissions. The repetition configuration may indicate a quantity of RVs associated with the uplink transmission for each of the UEs, a quantity of resource elements (REs) associated with each RV (e.g., with each repetition of each RV), and a quantity of repetitions associated with each RV. For example, a first RV (RV 0) may be repeated 4 times and a second RV (RV 2) may be repeated 4 times. Each UE performs M factor cover coding using the orthogonal cover code, and accordingly transmissions by the MUEs will be orthogonal. For example, each UE may perform the M factor cover coding using indicated rows of a Hadamard matrix, where the size of the Hadamard matrix is based on the size of M. The M factor cover coding may be performed on a symbol by symbol basis, a slot by slot basis.

OCC-based multiplexing of uplink transmissions by a set of multiple UEs may in some cases be applied in combination with UE pre-compensation of one or more of transmission timing impairments and/or transmission frequency impairments associated with changes in relative kinematics or positioning between the UE (e.g., the transmitter of the communication) and a satellite network entity, non-terrestrial network entity, and/or other receiver in a non-terrestrial network (NTN). The pre-compensation can be performed based on applying UE-determined compensation parameters to a signal prior to transmission, where the application of the compensation parameters cancels or reduces the impairment over the channel between the UE and the moving satellite or NTN network entity. The UE pre-compensation can be associated with a configured pre-compensation segment length, which is a time duration within which the UE cannot change, update, recalculate, etc., the UE-determined pre-compensation parameters. When segmented pre-compensation is implemented, the UE is configured to only update the pre-compensation information and/or parameters between pre-compensation segments. Pre-compensation segments can have lengths that are the same as or different from the slot length. In some cases, when the pre-compensation segment length is below a threshold duration for a particular slot length and OCC configuration implemented by a UE that implements both OCC and NPUSCH pre-compensation, the UE performing pre-compensation over the set of fixed pre-compensation segments can degrade the performance of the OCC-based multiplexing by causing a loss of orthogonality in data symbols and/or demodulation reference signal (DMRS) symbols that are spread over different pre-compensation segments where different pre-compensation parameters are applied.

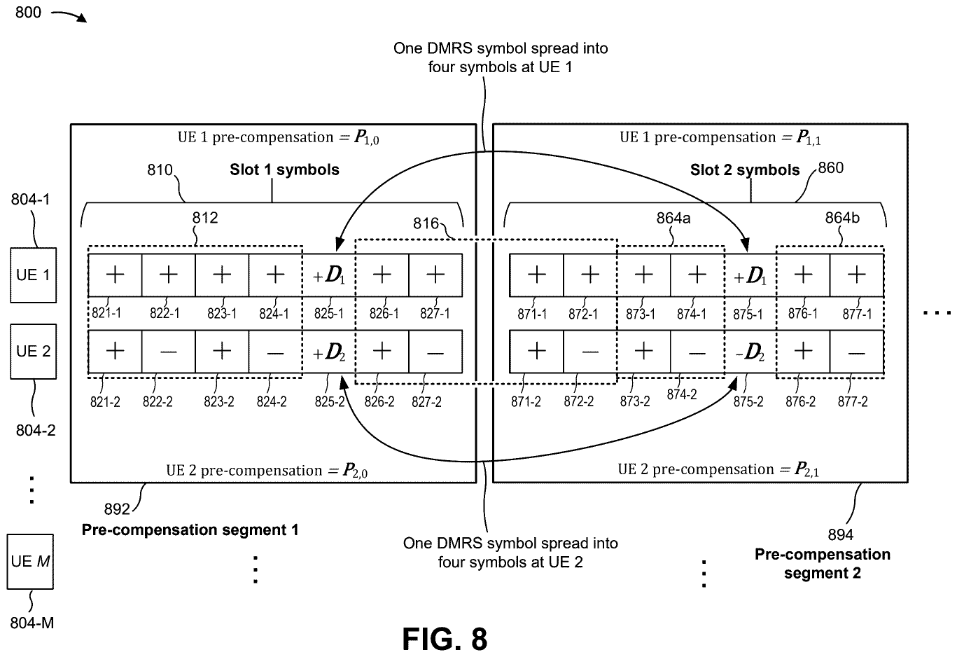

Systems, apparatuses, processes (also referred to as methods), and computer-readable media (collectively referred to as “systems and techniques”) are described herein that can be used to mitigate the performance loss in data symbols coded using OCC and compensated using UE pre-compensation over segmented pre-compensation intervals. For example, the systems and techniques can mitigate the performance loss associated with the example orthogonality loss in FIG. 8 based on adjusting the pre-compensation segment length (e.g. duration) to be longer than an initially configured segment length indicated by the network. Scaling the configured segment length to a scaled pre-compensated segment length that has a longer duration can mitigate the performance loss in data symbols and/or DMRS during OCC spreading.

In some cases, the systems and techniques can determine the scaled pre-compensation segment length from a plurality of candidate time values for the pre-compensation segment length. The selection for the scaled pre-compensation segment length can be implemented to increase the segment length to be longer than one or more durations that may cause phase inconsistencies across slots of the OCC structure, when OCC coding is used to multiplex UL transmission symbols in some OCC configurations. For example, the phase inconsistency or phase degradation of the OCC structure can correspond to a pre-compensation segment length that is shorter than the slot length (or multiple of the slot length) that is needed to transmit each spread OCC-coded symbol generated for an input symbol.

In some examples, the systems and techniques can be used to implement OCC with UE pre-compensation for NPUSCH NTN transmission based on scaling the pre-compensation segment length by the multiplexing order (e.g., OCC length) M indicated for the OCC configuration applied by a set of UEs being multiplexed. In some cases, the systems and techniques can be configured to calculate the scaled pre-compensation segment length using a minimum constraint on the segment duration based on OCC length M. For example, the systems and techniques can determine the scaled pre-compensation segment length subject to a 2·M ms minimum constraint applied on the scaled pre-compensation segment length. In some examples, the maximum threshold duration (e.g., 256 ms, etc.) may be used in combination with the minimum constraint.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

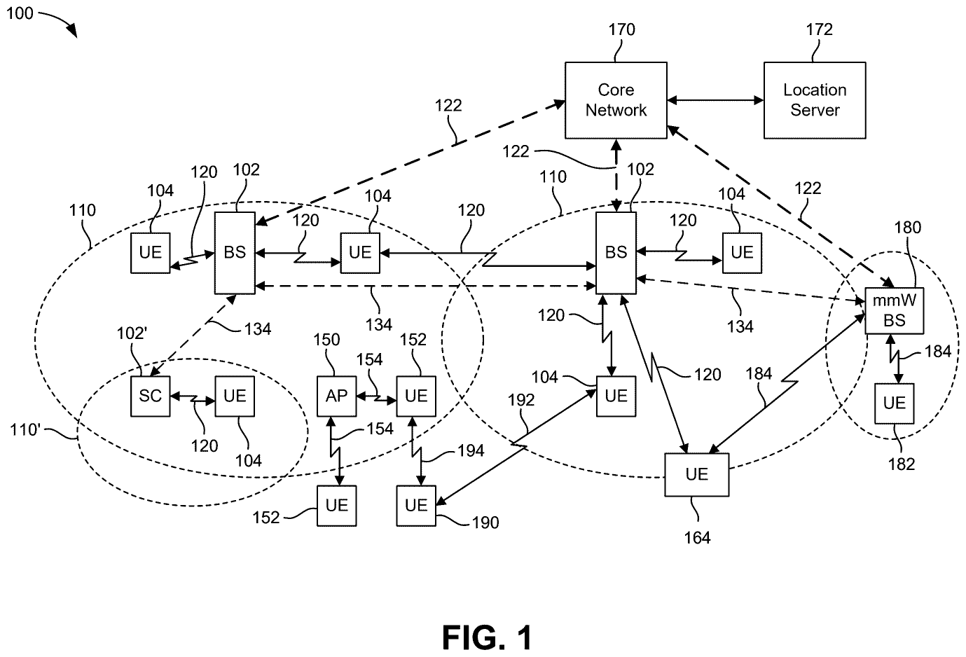

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 100 of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

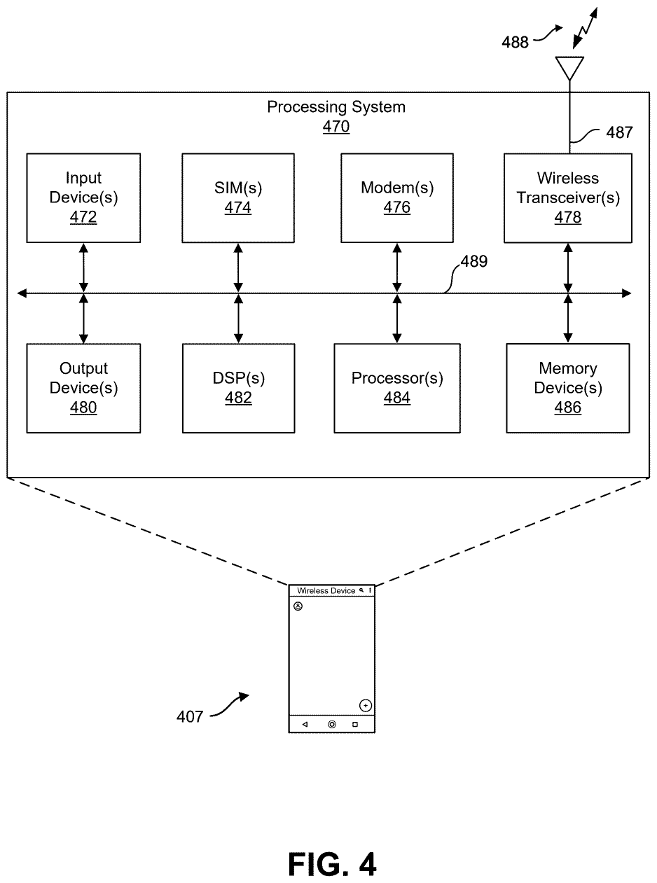

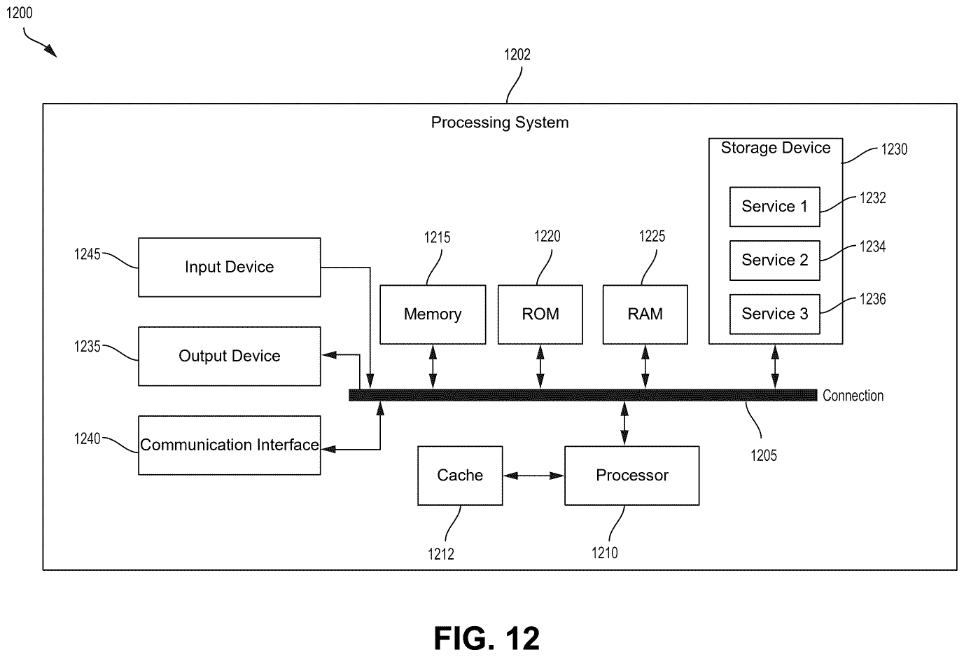

In some examples, the network entity 102 may include a processing system (e.g., such as the processing system 470 of FIG. 4 and/or the processing system 1202 of FIG. 12, etc.). Similarly, the network entity 180 (e.g., a millimeter wave (mmW) base station, etc.) may include a respective processing system (e.g., such as the processing system 470 of FIG. 4 and/or the processing system 1202 of FIG. 12, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

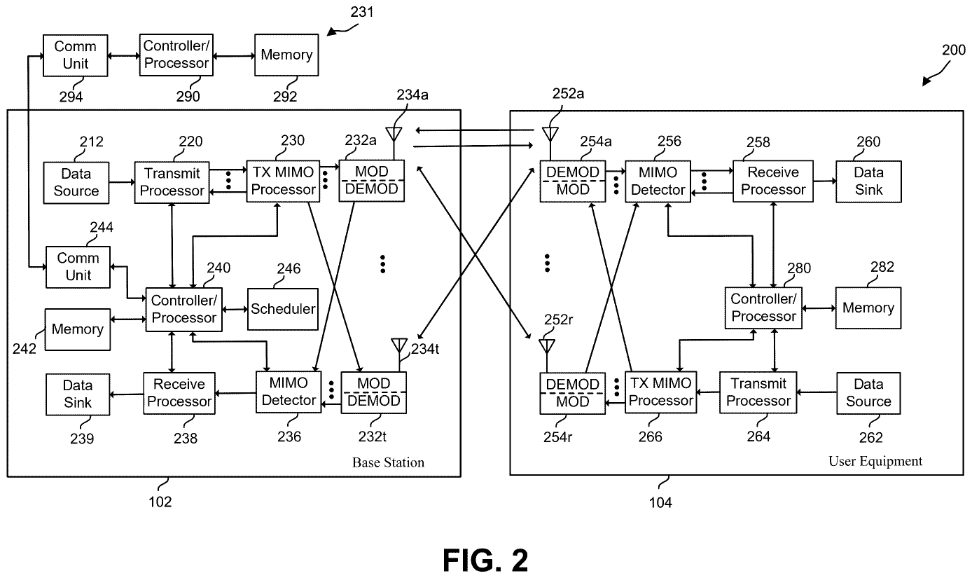

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

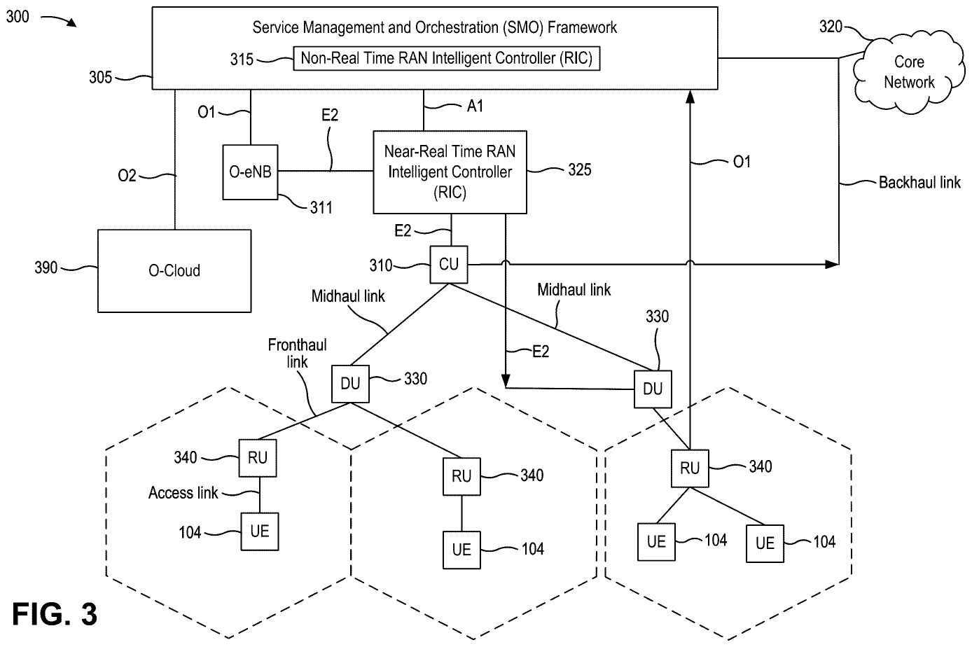

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 1202 of FIG. 12 (e.g., and the processing system 1202 of FIG. 12 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

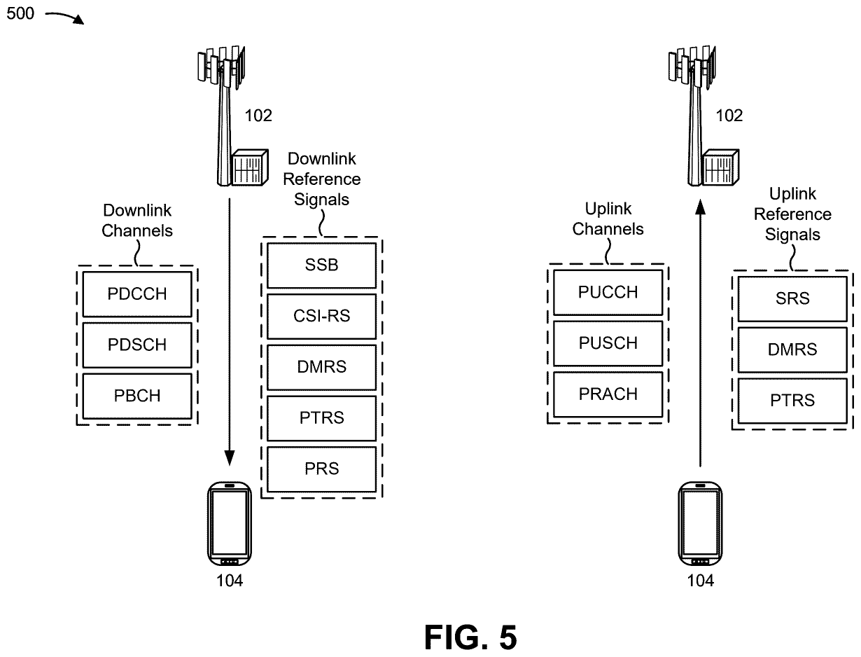

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

As noted above, multiple access schemes can be used to multiplex the transmissions of multiple UEs to increase the capacity of a carrier and/or a particular set of time-frequency resources. In some examples, a network entity (e.g., such as base station 102, etc.) may schedule uplink transmissions from multiple UEs (e.g., a number M of UEs) using the same time-frequency resources. The uplink transmissions from the multiple UEs are multiplexed together on the same time-frequency resources. For example, the transmitting UEs can be configured to perform M factor cover coding of the multiple transmissions, where M represents both the threshold number of UEs (e.g., the number of UEs≤M) and the multiplexing factor applied to schedule the multiple uplink transmissions on the same time-frequency resources. In some cases, the transmitting UEs can perform the cover coding of the multiple transmissions by using an orthogonal cover code (OCC) configuration corresponding to orthogonal M order UE multiplexing. In some examples, where the total number of repetitions performed for the cover coding is greater than 2 M, uplink capacity is increased from the network perspective based on the UEs being configured to apply the M factor cover coding (e.g., OCC with an OCC length of M, etc.) without increasing the quantity of time-frequency resources used for the multiplexed uplink transmissions.

In some cases, a network entity may provide a resource configuration that supports OCC for multiplexing transmissions by multiple UEs. In one illustrative example, the OCC-based multiplexing for multiple UEs can be implemented for a set of UEs (e.g., a plurality of UEs, etc.) that are configured to perform wireless communications with a non-terrestrial network (NTN). For example, the multiple UEs can perform UL transmission to a non-terrestrial network entity (e.g., a satellite, satellite gateway, etc. of the NTN), where respective UL transmissions from each UE of the multiple UEs are multiplexed together based on an OCC configuration implemented by the multiple UEs. In some aspects, each UE of the multiple UEs can be implemented as a narrowband (NB) Internet-of-Things (IoT) (NB-IoT) device. An NB-IoT device can also be referred to as an NB-IoT UE

A resource configuration that supports OCC for multiplexing transmissions by multiple UEs can be performed at a resource unit level or per a resource unit basis. In some implementations, OCC can be performed at a slot level, where the data from a UE is cover coded across orthogonal repetitions of slot-unit portions of the data. In some examples, OCC can be performed at a symbol level, where the data from a UE is cover coded across orthogonal repetitions of symbol-unit portions of the data.

For example, an OCC configuration using a multiplexing order (e.g., also referred to as an OCC length, and/or corresponding to the number of UEs for which UL transmission are multiplexed according to the same OCC configuration for a set of multiple UEs) of M=2 can be referred to as an OCC2 configuration, and may be used for multiplexing UL transmissions by a set of M=2 UEs. An OCC configuration using a multiplexing order of M=4 can be referred to as an OCC4 configuration, and may be used for multiplexing UL transmissions by a set of M=4 UEs. Implementing OCC for multiplexing a set of transmissions by a corresponding set of multiple UEs can increase the duration of the transmitted signals by a multiplexing factor (e.g., the multiplexing order noted above) M, where Mis also equal to the number of UEs that can be multiplexed in a set of UL transmissions for which the OCC configuration is applied (e.g., the number of UEs multiplexed ≤M).

The OCC-based multiplexing of the UE transmissions can be performed for UE UL transmissions. In some cases, the UE UL transmissions can be NTN transmissions, performed between UEs (e.g., which may be NB-IoT devices and/or NB-IoT UEs, etc.) and a non-terrestrial network entity such as a satellite. In some examples, the UE UL transmissions can be narrowband physical uplink shared channel (NPUSCH) transmissions. NPUSCH transmissions can be implemented and/or configured as NTN transmissions, and NTN transmissions may include NPUSCH transmissions.

As noted above, the systems and techniques described herein can be used to implement a pre-compensation segment length for performing timing and/or frequency compensation of the UL transmissions between UEs and an NTN (e.g., a non-terrestrial network entity, etc.), where the pre-compensation segment length is a duration or value of a period within which a UE does not change or modify the calculated pre-compensation parameters for applying timing compensation (e.g., transmission timing correction) or the calculated pre-compensation parameters for applying frequency compensation (e.g., transmission frequency and/or Doppler correction). In one illustrative example, the pre-compensation segment length associated with UE pre-compensation of UL transmissions from the UE to a non-terrestrial network entity is determined based on an OCC configuration for multiplexing transmissions by multiple UEs. In some aspects, the pre-compensation segment length is adjusted based on the value of the parameter M (e.g., the multiplexing order, OCC length, etc.) corresponding to the OCC configuration and the number of UEs in the set of UEs for which the respective UL transmissions are multiplexed together.

In one illustrative example, a resource configuration for OCC may be implemented for uplink UE transmissions comprising NPUSCH transmissions. In some examples, the NPUSCH format used for the UL transmission(s) may be Format 1 (e.g., NPUSCH Format=1), a quantity of resource units may be 1, a quantity of slots may be 16, a quantity of symbols (e.g., symbols per slot) may be 7, the subcarrier spacing (SCS) may be set to SCS=3.75 kHz, and the slot duration (e.g., Tₛₗₒₜ) may be 2 milliseconds (e.g., Tₛₗₒₜ=2 ms).

For example, the systems and techniques may be used to implement pre-compensation for NPUSCH NTN UL transmissions with OCC, based on implementing a pre-compensation segment length that is based on the multiplexing order M of the OCC configuration applied by the UEs performing the NPUSCH NTN UL transmissions. In some aspects, the systems and techniques may operate in a wireless network comprising an NB-IoT system with single tone NPUSCH using OCC2 (e.g., an OCC configuration with the multiplexing order M set to M=2) with SCS=3.75 kHz. In some aspects, the OCC configuration can correspond to symbol-wise OCC, where the repetition nature of cover coded uplink transmissions corresponds to the data from M=2 UEs being cover coded across repetitions of symbols in an orthogonal manner according to the OCC configuration. In some aspects, OCC2 symbol-wise configurations can correspond to one input unit of data being cover coded across orthogonal repetitions comprising two output units of data. For example, in the symbol-wise OCC configuration, the unit of data (e.g., for the input unit and the output unit) is one symbol of data for the UE's uplink transmission (e.g., UL NPUSCH NTN transmission, etc.). In such examples, the OCC2 symbol-wise configuration can correspond to one symbol of data being spread into two symbols using OCC, where the two OCC-spread symbols for the one unit of input data are cover coded in an orthogonal manner.

For the example NB-IoT system with single tone NPUSCH using OCC2 with SCS=3.75 kHz, one slot has 7 symbols. For the SCS of 3.75 kHz, the slot duration=2 ms. The symbol duration= 2/7 ms. Based on a DMRS configuration associated with the UE, one or more DMRS symbols can be included or inserted within the UL transmission (e.g., NPUSCH UL transmission, etc.) for each UE of the M=2 set of multiple UEs that are multiplexed together according to an OCC2 symbol-wise configuration. The DMRS symbols associated with an uplink transmission of a respective UE applying the OCC configuration may also be cover coded according to the same OCC configuration, and/or according to a different OCC configuration (e.g., a DMRS-specific OCC configuration) from the OCC configuration used for the data transmission (e.g., a data-specific OCC configuration). In examples where the UE uses OCC2 for multiplexing of the NPUSCH NTN transmissions, the OCC2 multiplexing order of M=2 may be used for both the OCC-based multiplexing of the data symbols of the transmission and the OCC-based multiplexing of the DMRS symbols of the transmission.

In some aspects, a UE can be configured (e.g., by an OCC configuration) for transmitting symbols that have been configured with OCC (e.g., symbol-wise OCC). For example, the UEs associated with an OCC2 (e.g., M=2) configuration can transmit symbols that have been configured with OCC, based on each of the M=2 UEs transmitting a respective first symbol and a respective second symbol. The notation of the symbols configured with OCC can be represented as sᵢ^{j}, which corresponds to an OCC symbol index j at a particular UE i of the set of M UEs associated with the multiplexing order M of the OCC configuration. The UL transmissions (e.g., NPUSCH transmissions) can be grouped into a set by the symbol index j, can be grouped into a set by the UE index i, and/or various combinations thereof.

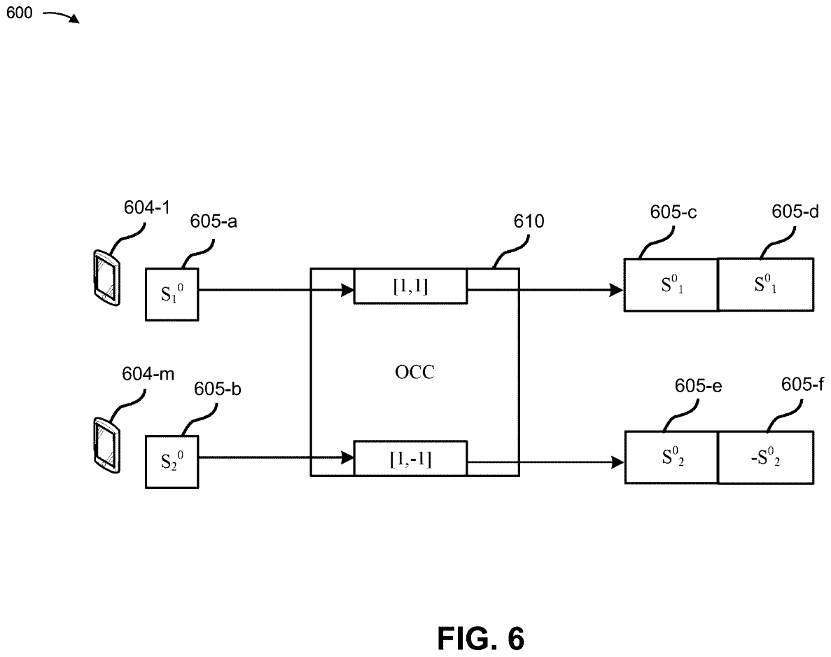

FIG. 6 illustrates an example of an encoding configuration 600 that supports orthogonal cover coding (OCC) for multiplexing transmissions by multiple UEs, in accordance with some examples. To perform the OCC coding, a UE (e.g., UE 604-1, 604-m, etc., of FIG. 6) can use a configured OCC coding matrix indicated in the OCC configuration. The matrix may be used by the UE to implement OCC coding for the symbols that have been configured with OCC. For example, in an OCC2 configuration with M=2 UEs, the symbols of a first UE 604-1 may perform OCC coding 610 to apply a [1,1] vector of the matrix to the sets of symbols and index. As an additional part of the OCC coding 610, a second UE 604-m may apply a vector of [1, −1] to the symbol sequence.

In some aspects, FIG. 6 illustrates an example of an encoding configuration 600 for multiplexing transmissions by multiple UEs (e.g., UE 604-1, UE 604-m, etc.) in accordance with one or more aspects of the present disclosure. The UE 604-1 and the UE 604-m may be examples of UE 104, as described with respect to any of FIGS. 1-5 above. The encoding configuration 600 may be used to cover code multiple units or entities of a signal (e.g., information, data, etc., included within and/or associated with an UL transmission of a UE, including an NPUSCH NTN UL transmission as noted above). The encoding configuration 600 can be used to cover code resource elements (REs), slots, symbols, resource units (RUs), redundancy versions (RVs), etc., in accordance with an orthogonal cover coding configuration to generate orthogonal transmissions for the UE 604-1 and the UE 604-m as described herein.

In the encoding configuration 600 for performing OCC, the UE 604-1 may input a data symbol 605-a to a row or column of a Hadamard matrix for OCC coding 610 and the UE 604-m may input a second data symbol 605-d for OCC coding 610 row or column of a Hadamard matrix. A row or column of the Hadamard matrix used for OCC coding 610 may also be referred to as an “OCC codeword.” The Hadamard matrix of the OCC coding 610 may be a 2×2 matrix, for the example of OCC performed using M=2 (e.g., a matrix comprising two rows and two columns). The Hadamard matrix for OCC coding 610 with OCC factor M can be a matrix of size M×M. The first row may correspond to a vector [1,1] that, when applied to the input comprising the first data symbol 605-a from the first UE 604-1, outputs a product including a third symbol 605-c and a fourth symbol 605-d. The third symbol 605-c and the fourth symbol 605-d may have the same values as the input of first symbol 605-a based on the vector [1,1] not applying a magnitude change or a sign change to the input comprising first data symbol 605-a. The input symbol 605-a can be represented as the symbol entity s₁⁰. The symbols 605-c and 605-d generated as output by the OCC coding 610 for the first UE 604-1 and first input data symbol 605-a can also be represented as s₁⁰, and may also be referred to as spread entities or spread symbols with an OCC length of 2 (e.g., spread entities or spread symbols with an OCC length equal to the multiplexing order M and/or the number of UEs M). In some aspects, the input data symbol 605-a can be referred to as a non-OCC symbol and/or a non-OCC-coded symbol. The spread symbols 605-c and 605-d correspond to the input data symbol 605-a and the first UE 604-1, and may also be referred to as the OCC symbols and/or the spread OCC symbols and/or the OCC-coded symbols, etc., for the input data symbol 605-a and/or for the first UE 604-1.

The second row of the matrix (which can be referred to as an OCC coding matrix) of the OCC coding 610 may correspond to a vector of [1, −1]. The second row, when given as an input the data symbol 605-b by the second UE 604-m, outputs a product including a fifth symbol 605-e and a sixth symbol 605-f. The sixth symbol 605-f is a negative output of the input symbol 605-b, based on a negative value (e.g., −1) being applied in the vector [1, −1] of the matrix of the OCC coding 610. Applying the OCC coding 610 matrix in this manner to the input symbols 605-a and 605-b from the M=2 UEs (e.g., UE 604-1 and UE 604-m) produces orthogonal outputs (e.g., the spread symbols or OCC-coded symbols 605-c, 605-d, 605-e, 605-f are orthogonal outputs of the OCC coding 610) and accordingly, transmissions from the UE 604-1 and the UE 604-m are orthogonal and therefore do not interfere with each other and can support efficient OCC-based multiplexing as noted above. The encoding applied using the Hadamard matrix of the OCC coding 610 configuration may be applied to a set of symbols for each UE (e.g., sᵢ^{j} comprising the respective set of symbols {0, 1, . . . , j} for each of the i UEs, etc.).

In some examples, each slot associated with uplink transmission by the UE (e.g., each slot associated with uplink transmission for OCC-coded spread symbols corresponding to one or more data symbols for a UE), may comprise 7 symbols. For example, each slot can have 7 symbols, with a symbol duration=(slot duration)/7 symbols. In one illustrative example, each slot associated with UL transmission and OCC-based multiplexing by the UE 604-1, 604-m, etc., associated with the OCC encoding configuration 600 can include 6 data symbols and 1 DMRS, and the number of symbols per slot may be 7 (e.g., NsymbUL=7 [1]). The input to the encoding matrix of the OCC coding 610 may include the six symbols sᵢ⁰, sᵢ¹, sᵢ², sᵢ³, sᵢ⁴, sᵢ⁵, and can further include the one DMRS symbol per slot. In some examples, involving transmission at a slot level, the input to the matrix of the OCC coding 610 may be in slots instead of symbols.

In an example corresponding to OCC-based multiplexing of four UEs 604-1, . . . , 604-m (e.g., an OCC4 configuration, with M=4), the OCC coding matrix (of the OCC coding 610) may be a 4×4 Hadamard matrix having four rows and four columns. Similarly, the OCC implementation for the example of multiplexing the UL transmissions using OCC coding 610 for four UEs (e.g., UE 604-1, . . . , UE 604-m, etc.) may be performed using an OCC4 configuration and multiplexing order of M=4 to configure the OCC coding 610 and/or the encoding configuration 600 of FIG. 6, etc. In such examples, the OCC coding matrix of the OCC coding 610 with an OCC4 configuration may include a first row vector of [1, 1, 1, 1], a second row vector of [1, −1, 1, −1], a third row vector [1, 1, −1, −1], and a fourth row vector [1, −1, −1, 1].

In some aspects, by providing segmented pre-compensation with a pre-compensation segment length (e.g., duration) that is based on an OCC configuration used for multiplexing transmissions from multiple UEs, the systems and techniques can be used for NPUSCH capacity enhancement with OCC. For example, OCC can be used for PUSCH capacity enhancement based on multiplexing multiple UEs (e.g., two, four, etc.) in a single 3.75 kHz or 15 kHz subcarrier via orthogonal cover codes for NPUSCH format 1. In some cases, multi-tone support or implementations for larger SCS values (e.g., such as SCS=15 kHz, etc.) may also be considered.

In some cases, SCS=3.75 kHz can correspond to symbol-level OCC2 that can be performed for two UEs and a multiplexing order (e.g., OCC length) of M=2. The symbol-level OCC2 for SCS=3.75 kHz can be based on single SC NPUSCH for connected mode UEs. In another example, slot-level OCC2 can be performed for SCS=15 kHz single SC NPUSCH transmissions, etc.

As noted above, NPUSCH transmissions can be UL transmissions from one or more UEs to a non-terrestrial network entity, such as a satellite. NTN communications, including NPUSCH transmissions, between a UE and a non-terrestrial network entity can use pre-compensation information calculated to provide respective corrections to time and/or frequency impairments associated with the orbital motion and trajectory of the non-terrestrial network entity (e.g., satellite) relative to the UE performing communication with the moving satellite. The pre-compensation information may include timing pre-compensation information (e.g., transmission timing corrections or compensations, etc.), frequency pre-compensation information (e.g., transmission frequency corrections or Doppler compensations, etc.), or both. The pre-compensation can be performed, and the pre-compensation parameters may be determined, by the NTN and/or the non-terrestrial network entity (e.g., satellite). In some examples, the pre-compensation can be performed, and the pre-compensation parameters can be determined, by the UE. Pre-compensation can also be performed by various combinations of the UE and the non-terrestrial network entity.

In the case of NPUSCH, the transmissions are UL transmissions from the UE to the non-terrestrial network entity of the NTN. For NPUSCH UL, all UEs may be configured to perform UE-side pre-compensation to correct for timing and/or frequency impairments due to the relative motion and orbital trajectory between the UE and the satellite network entity. For example, satellite ephemeris or other trajectory information of the non-terrestrial network entity can be provided to the UE (e.g., by the satellite network entity, or other network entity or gateway associated with the NTN, etc.), and the UE may determine pre-compensation parameters to correct time or frequency impairments at a future time and position of the UE and satellite. For example, the pre-compensation parameters can be calculated using the ephemeris information of a satellite, the current location of the satellite, and the current location of the UE, such that the calculated pre-compensation parameters provide a correction of predicted time/frequency impairments at the future time (e.g., the scheduled transmission time of an UL transmission from the UE to the satellite network entity). Based on the ephemeris information obtained from the satellite non-terrestrial network entity, a UE can determine (e.g., estimate) the impairments caused by the movement of the satellite relative to the location of the UE. The pre-compensation parameters can be determined to apply a compensation for correcting the estimated impairments at the time of a scheduled (e.g., upcoming, future, etc.) NPUSCH transmission from the UE to the satellite non-terrestrial network entity.

In some cases, the pre-compensation techniques used for UE pre-compensation of time and/or frequency impairments corresponding to movement(s) of a satellite or other non-terrestrial network entity can result in a pre-compensation segment length or duration that breaks the structure of the OCC coding that may be used for multiplexing the NPUSCH UL transmission of multiple UEs together for capacity enhancement on the UL resources of the NTN or satellite network entity. For example, various pre-compensation segment length durations may be configured for updating or refreshing the UE-estimated pre-compensation parameters, where the various pre-compensation segment length durations cause non-orthogonality of DMRS symbols in the OCC-coded (e.g., OCC multiplexed NPUSCH UL transmissions from the set of UEs). In some examples, the various pre-compensation segment length durations can cause non-orthogonality of data symbols and/or DMRS symbols in the OCC-coded (e.g., OCC multiplexed NPUSCH UL transmissions).

In one illustrative example, the systems and techniques described herein can be used to increase the capacity gains from NB-IoT NTN systems using NPUSCH with OCC for multiplexing UL transmissions of multiple UEs. The pre-compensation segment length or duration can be determined and implemented as a variable segment length that is based on the OCC configuration used for the OCC-based multiplexing applied to the set of UE uplink transmissions. The pre-compensation segment length duration can be based on the multiplexing order or OCC length M configured for the OCC-based multiplexing and/or indicated by an OCC configuration for the set of UEs. The variable pre-compensation segment length duration based on the OCC configuration and/or multiplexing order M can be used to increase the reliability of the pre-compensation for correcting impairments of time and/or frequency errors between the UEs and a satellite or non-terrestrial network entity. The variable pre-compensation segment length duration can be configured to not impact the performance of OCC.

In some examples, a UE can obtain the ephemeris information associated with determining pre-compensation information (e.g., such as one or more UE pre-compensation parameter values) for UL transmissions (e.g., NPUSCH transmissions) between the UE and a satellite NTN network entity. The ephemeris information can in at least some examples be received by the UE in a system information block (SIB) broadcast by the NTN and/or the satellite network entity. In some cases, the ephemeris information can be obtained or received by the UE in a SIB31 broadcast from the satellite NTN network entity. Based on the ephemeris information (e.g., satellite location, velocity, time stamp, trajectory, orbital parameters, etc.) and the location information of the UE (e.g., determined using GNSS, etc.), the UE can calculate the UE pre-compensation parameters for a future or scheduled UL NPUSCH from the UE to the satellite network entity. In some aspects, the UE pre-compensation for NTN transmissions can be applied as segment-wise pre-compensation according to a configured pre-compensation segment duration value.

The pre-compensation segment length can be the duration (e.g., in units of time, such as milliseconds (ms)) within which the time and frequency compensation applied by the UE will remain constant within the segment. For example, the pre-compensation segment length can correspond to a segment duration or time window where the UE pre-compensation information remains constant (e.g., is unchanged from the pre-compensation information or parameters that were determined or otherwise available at the start of the current pre-compensation segment). A UE configured to perform segment-wise pre-compensation (e.g., also referred to as segmented pre-compensation) is configured to only change the pre-compensation information by updating calculated transmission timing compensation parameters and/or calculated transmission frequency compensation parameters when changing from one segment to another. In one illustrative example, the pre-compensation segment length can be a configured value or parameter signaled to the UE by the network (e.g., the NTN, satellite NTN network entity, etc.). In some cases, the pre-compensation segment length can be indicated using an npusch-TxDuration-r17 parameter or information element (IE). The parameter npusch-TxDuration-r17 can be a numerical value in units of time, such as milliseconds (ms). In some cases, the pre-compensation segment length can be indicated using the npusch-TxDuration-r17 parameter according to 3GPP TS 36.331.

For example, a signaled or configured npusch-TxDuration-r17 parameter with a value of X can be indicative of a pre-compensation segment length of X ms, and can be used to configure the UE to calculate the pre-compensation NTN transmission parameters every X ms. The parameter npusch-Tx-Duration-r17 can be used to implement a periodic update or refresh rate of the UE pre-compensation information and parameters used for correcting the impairments on the UL transmissions (e.g., NPUSCH transmission) from the UE to the NTN satellite network entity. At the start of a pre-compensation segment length of X ms, the UE may determine a calculated or scaled pre-compensation information, and will then apply this calculated pre-compensation information for the entirety of the X ms pre-compensation segment length. At the end of the first pre-compensation segment (e.g., after X ms have elapsed), the UE can recalculate some or all of the pre-compensation parameters and/or can determine scaled pre-compensation information to update the particular set of UE pre-compensation parameters that will be applied to the following pre-compensation segment length and any following NPUSCH transmissions, etc.

In some aspects, the signaled or configured value of the npusch-TxDuration-r17 parameter (e.g., pre-compensation segment length) can be determined from a plurality of configured time values. For example, the pre-compensation segment length can be selected from a plurality of candidate time durations configured for the UE and/or configured as candidate time duration values for the npusch-TxDuration-r17 parameter. For example, the npusch-TxDuration-r17 parameter can be configured as a selection from SEQUENCE {ENUMERATED {ms2, ms4, ms8, ms16, ms32, ms64, ms128, ms256}}. In this example, the possible (e.g., candidate) values for the npusch-TxDuration-r17 parameter are the plurality of candidate time duration values {2 milliseconds, 4 milliseconds, 8 milliseconds, 16 milliseconds, 32 milliseconds, 64 milliseconds, 128 milliseconds, 256 milliseconds}. The pre-compensation segment length where the UE is permitted to update or recalculate the pre-compensation parameters may be selected from the plurality of available candidate time values 2 ms, 4 ms, 8 ms, 16 ms, 32 ms, 64 ms, 128 ms, 256 ms.

As noted above, in some cases the plurality of candidate time values for the pre-compensation segment length (e.g., the available values for the parameter npusch-Tx-Duration-r17) may cause phase inconsistencies across slots of the OCC structure, when OCC coding is used to multiplex UL transmission symbols in some OCC configurations. For example, the phase inconsistency or phase degradation of the OCC structure can correspond to a pre-compensation segment length that is shorter than the slot length (or multiple of the slot length) that is needed to transmit each spread OCC-coded symbol generated for an input symbol (e.g., for OCC2, the two spread OCC-coded symbols generated for one input symbol; for OCC4, the four spread OCC-coded symbols generated for one input symbol; etc.).

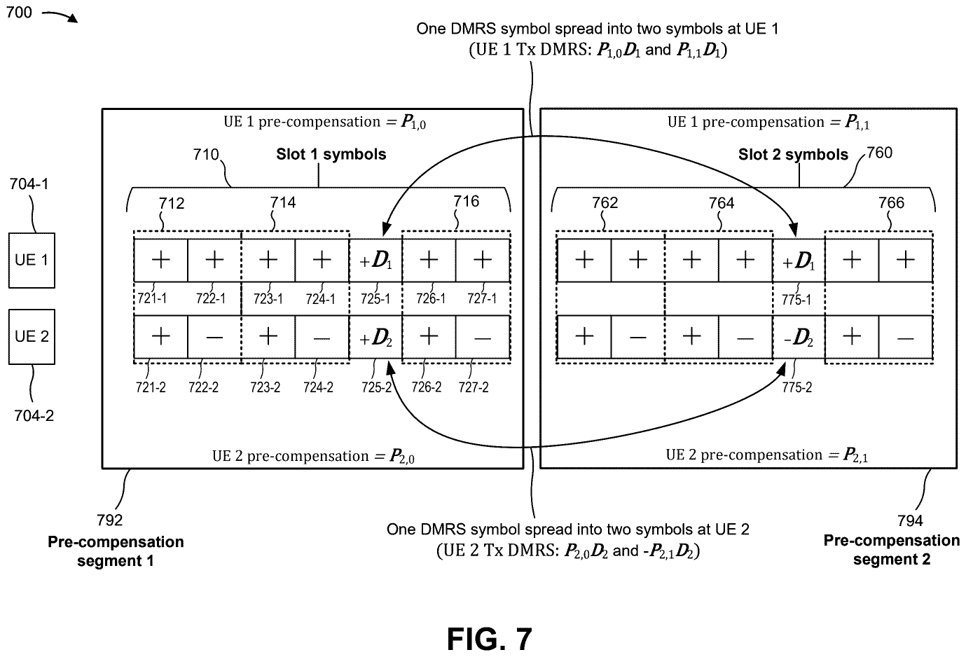

FIG. 7 is a transmission timing diagram 700 illustrating a first example of uplink (UL) transmissions by multiple UEs configured for OCC multiplexing using a first multiplexing factor, where the UL transmissions are NTN transmissions (e.g., NPUSCH UL transmissions to a satellite network entity). In response to the UL transmission being NTN transmissions, the transmission timing diagram 700 includes segmented pre-compensation that is applied by each respective UE being multiplexed to correct for impairments on the link to the moving satellite network entity. For example, the transmission timing diagram 700 can correspond to an NB-IoT system with single tone NPUSCH and using an OCC2 configuration (e.g., an OCC configuration with M=2) and SCS=3.75 kHz. Based on the multiplexing order (e.g., OCC length) of M=2, the transmission timing diagram 700 corresponds to multiplexing of the uplink transmissions from two UEs, comprising the first UE 704-1 and the second UE 704-2.

The UEs 704-1 and 704-2 may implement symbol-wise OCC, where, according to the OCC2 configuration, each input symbol of data at the UE is spread into two symbols using OCC. As in the examples above, one slot can correspond to seven symbols, with the 3.75 kHz SCS corresponding to a slot duration of 2 ms and a symbol duration of 2/7 ms. For example, a first slot (e.g., Slot 1) 710 includes the seven symbols 721-1, 722-1, 723-1, 724-1, 725-1, 726-1, 727-1 corresponding to the first UE 704-1. The first slot 710 also includes the seven symbols 721-2, 722-2, 723-2, 724-2, 725-2, 726-2, 727-2 corresponding to the second UE 704-2. The second slot (e.g., Slot 2) is the next slot after Slot 1, and also includes a corresponding seven symbols for each of first UE 704-1 and second UE 704-2.

A first input data symbol for UE 704-1 and a first input data symbol for UE 704-2 can be OCC coded using the respective vectors [1,1] and [1, −1] of the OCC coding Hadamard matrix (e.g., as noted above for the example of FIG. 6, etc.), to thereby obtain a first set of OCC-coded symbols 712. The first set of OCC-coded symbols 712 includes the two spread symbols 721-1 and 722-1 corresponding to the one input symbol for UE 704-1, and the two spread symbols 721-2 and 722-2 corresponding to the one input symbol for UE 704-2. The sign of 722-2 is negative, corresponding to the vector [1, −1] used to apply the OCC coding matrix to the input for UE 704-2.

A second respective data symbol at the input for UEs 704-1 and 704-2 corresponds to the OCC-coded symbols 714, which includes the two positive-signed spread symbols 723-1 and 724-1 for the first UE 704-1, and includes the positive and negative-signed pair of spread symbols 723-2 and 724-2 for the second UE 704-2.

A third respective data symbol at the input for UEs 704-1 and 704-2 corresponds to the OCC-coded symbols 716, which includes the two positive-signed spread symbols 726-1 and 727-1 for the first UE 704-1, and includes the positive and negative-signed pair of spread symbols 726-2 and 727-2 for the second UE 704-2.

Each respective UE can perform UE pre-compensation for the NPUSCH uplink transmissions to a satellite or other NTN network entity. In this example, the pre-compensation segment length (e.g., time duration) is equal to 2 ms, and can be a configured value selected or indicated to the UEs 704-1, 704-2 by the network. A first pre-compensation segment 792 corresponds to a first time window (e.g., time interval, etc.) having a length equal to the 2 ms pre-compensation segment length. A second pre-compensation segment 794 corresponds to a second time window with a 2 ms length given by the pre-compensation segment. In this example, the length of the pre-compensation segment is the same as the slot duration (e.g., each is set to 2 ms). The seven symbols of Slot 1 710 are included within the 2 ms first pre-compensation segment 792, and the seven symbols of Slot 2 760 are included within the 2 ms second pre-compensation segment 794.

The pre-compensation segment length can also be referred to as the UL transmission segment length for NPUSCH, and may correspond to the duration of time during which the applied pre-compensation parameters at a respective UE (e.g., UE 704-1, 704-2) shall not be changed by the UE. For example, during and within the first pre-compensation segment 792, the first UE 704-1 uses its calculated set of pre-compensation parameters P_{1,0} without any changes or updates. During and within the first pre-compensation segment 792, the second UE 704-2 uses its calculated set of pre-compensation parameters P_{2,0} without any changes or updates.

At the end of the first pre-compensation segment 792, the UEs 704-1 and/or 704-2 may change, update, and/or recalculate, etc., their respective pre-compensation parameters. For example, the first UE 704-1 may determine updated pre-compensation parameters P_{1,1}, which are used by the first UE 704-1 during and within the second pre-compensation segment 794 without any further changes permitted. The second UE 704-2 may determine updated pre-compensation parameters P_{2,1}, which are used by the second UE 704-2 during and within the second pre-compensation segment 794 without any further changes permitted.

The sets of OCC-coded symbols 712, 714, and 716 are included entirely within the first slot 710 and the first pre-compensation segment 792. Application of the respective UE pre-compensation parameters P_{1,0} and P_{2,0} to the OCC-coded symbols 712, 714, and 716 maintains orthogonality, as all six of the spread symbols included in the three OCC-coded symbols 712, 714, 716 are pre-compensated by a respective pre-compensation parameter that does not change. Likewise, the OCC-coded symbols 762, 764, 766 of the second slot 760 are included entirely within the second slot 760 and the second pre-compensation segment 794, and undergo OCC-coding and subsequent pre-compensation using the constant pre-compensation parameters P_{1,1} and P_{2,1} that are held unchanged by the UEs 704-1 and 704-2 within the second slot 760 and the second pre-compensation segment 794. The OCC-coded symbols 762, 764, 766 maintain orthogonality as well, due to application of the same pre-compensation parameters to the spread symbols included in the respective sets of OCC-coded symbols 762, 764, 766.

One or more DMRS symbols may also be included in the UE Tx slots of the example transmission timing diagram 700. The DMRS can also be coded using OCC, and may use the same OCC2 configuration as the data symbols associated with UEs 704-1, 704-2. For example, one DMRS symbol for UE 704-1 is spread into the two UE1 DMRS symbols 725-1 and 775-1, with the spreading implemented across slots and across pre-compensation segments. The first UE1 DMRS symbol 725-1 is within the first slot 710 and first pre-compensation segment 792, and is pre-compensated according to P_{1,0}. The second UE1 DMRS symbol 775-1 is within the second slot 760 and second pre-compensation segment 794, and is pre-compensated according to P_{1,1}.

One input DMRS symbol for UE 704-2 is likewise spread into the two UE2 DMRS symbols 725-2 and 775-2, with the spreading again implemented across slots 710, 760 and across pre-compensation segments 792, 794. The first UE2 DMRS symbol 725-2 is pre-compensated according to P_{2,0}, and the second UE2 DMRS symbol 775-2 is pre-compensated according to P_{2,1}.

Based on the DMRS for each UE being spread into two symbols in two different pre-compensation segments, the DMRS at each UE's Tx will be P_{1,0}D₁ for the UE1 DMRS symbol 725-1 within the first slot 710 and P_{2,0}D₂ for the UE2 DMRS symbol 725-2 also within the first slot 710. Within the second slot 760, the DMRS at each UE's Tx will be P_{1,1}D₁ for the UE1 DMRS symbol 775-1 and −P_{2,1}D₂ for the UE2 DMRS symbol 775-2.

If the pre-compensation parameters for either of UE1 704-1 or UE2 704-2 change between the first slot 710/first pre-compensation segment 792 and the second slot 760/second pre-compensation segment 794, orthogonality of the spread DMRS symbols may be lost or broken. For example, if P_{1,0}≠P_{1,1} (e.g., corresponding to UE1 704-1 performing updates and/or recalculation of pre-compensation parameters between first pre-compensation segment 792 and second pre-compensation segment 794), and/or if P_{2,0}≠P_{2,1} (e.g., corresponding to UE2 704-2 performing updates and/or recalculation of pre-compensation parameters between first pre-compensation segment 792 and second pre-compensation segment 794), then the OCC-coded Tx DMRS outputs will no longer be orthogonal. The difference in pre-compensation applied for the two pre-compensation segments 792, 794 can introduce a phase shift between the respective DMRS symbols in each segment/slot, and the introduced phase shift can break the orthogonality of the OCC cover coding.

For example, the phase shift introduced by different pre-compensation parameters applied across segments can cause a loss of orthogonality that impacts system performance by causing degradation of channel estimation. For example, the DMRS is not successfully received based on the loss of orthogonality, which can impair the ability for the NB-IoT system to perform channel estimation based on a successfully received and decoded DMRS. In the example OCC and NTN pre-compensation configuration of the transmission timing diagram 700 of FIG. 7, setting the pre-compensation segment length equal to 2 ms breaks DMRS.

In one illustrative example, by increasing the pre-compensation segment length to at least 4 ms duration (e.g., performing pre-compensation updates or recalculation every 4 ms by the UEs, rather than every 2 ms) can result in the same compensation information or pre-compensation parameters being applied to both of the two spread DMRS symbols across slot 1 710 and slot 2 760. In this example of an increased, 4 ms pre-compensation segment length, the data symbols and the DMRS symbols can be successfully OCC coded and multiplexed with pre-compensation performed without breaking orthogonality. For example, changing the pre-compensation segment length to 4 ms causes the UE1 704-1 to use the same pre-compensation parameters P_{1,0} in both the first slot 710 and the second slot 760, and similarly causes the UE2 704-2 to use the same pre-compensation parameters P_{2,0} in both the first slot 710 and the second slot 760.

FIG. 8 is a transmission timing diagram illustrating a second example of segmented pre-compensation 800 for NTN UL transmissions by multiple UEs configured for OCC multiplexing using a second multiplexing factor. A first UE1 804-1 can correspond to the first UE1 704-1 of FIG. 7, a second UE2 804-2 can correspond to UE2 704-2 of FIG. 7, etc. UE_M 804-M can be an additional UE, up to the maximum number of UEs that can be multiplexed by an OCC configuration with multiplexing order M. For example, FIG. 8 can correspond to an example of an NB-IoT system with single tone NPUSCH using OCC4 (e.g., with M=4), and the UE_M 804-M represents a fourth UE that is multiplexed with the UE1 804-1, the UE2 804-2, and a third UE3 that is not shown in the diagram.

The OCC configuration of FIG. 8 can be an OCC4 configuration with M=4, with remaining OCC configuration parameters the same as those in the example OCC2 configuration with M=2 in the example of FIG. 7 above. The SCS can again be 3.75 kHz, symbol-wise OCC configuration can be performed for slots with seven symbols, a 2 ms slot duration, and a 2/7 ms symbol duration, etc.

The first slot 810 can correspond to the first slot 710 of FIG. 7, and the second slot 860 can correspond to the second slot 760 of FIG. 7. The pre-compensation segment length can be 2 ms, and the first pre-compensation segment 892 can correspond to the first pre-compensation segment 792 of FIG. 7, and the second pre-compensation segment 894 can correspond to the second pre-compensation segment 794 of FIG. 7. The seven symbols associated with UE1 804-1 in slot 1 810 are the symbols 821-1, 822-2, . . . , 827-1, which can correspond to the symbols 721-1, 722-1, . . . , 727-1 of FIG. 7. The seven symbols associated with UE2 804-2 in slot 1 810 are the symbols 821-2, 822-2, . . . , 827-2 and can correspond to the symbols 721-2, 722-2, . . . , 727-2 of FIG. 7.

The first UE1 804-1 can determine and apply the first set of pre-compensation parameters P_{1,0} during and within the first slot 810, and may update to the recalculated (e.g., updated) pre-compensation parameters P_{1,1} applied during and within the second slot 860. The second UE2 804-2 can determine and apply the first set of pre-compensation parameters P_{2,0} during and within the first slot 810, and may update to the recalculated (e.g., updated) pre-compensation parameters P_{2,1} for use during the second slot 860.

For an example of an OCC4 configuration used to multiplex transmissions of four UEs together (e.g., UE1 804-1, UE2 804-2, a UE3 not shown, and a fourth UE_M 804-M), each input symbol at the UE Tx is spread into four OCC-coded symbols. For example, the first OCC symbol set 812 includes the four spread symbols 821-1, 822-1, 823-1, and 824-1 for UE1 804-1; includes the four spread symbols 821-2, 822-2, 823-2, and 824-2 for UE2 804-2; includes a respective four spread symbols for the third UE; and includes a respective four spread symbols for the fourth UE_M 804-M.

The next set of OCC symbols is the OCC symbol set 816, which must be split across the slot 1 symbols that are within the first pre-compensation segment 892 and the slot 2 symbols that are within the second pre-compensation segment 894. For example, the OCC symbol set 816 includes a first portion of symbols in slot 1/pre-compensation segment 1 892 for all four UEs (e.g., symbols 826-1, 827-1 for UE1; 826-2, 827-2 for UE2; . . . , etc.) and includes a second portion of symbols in slot 2/pre-compensation segment 2 894 for all four UEs (e.g., symbols 871-1, 872-1 for UE1; 871-2, 872-2 for UE 2; . . . , etc.). A third set of OCC symbols can include a first portion 864a (e.g., symbols 873-1, 874-1, 873-2, and 874-2) and a second portion 864b (e.g., symbols 876-1, 877-1, 876-2, and 877-2), split by the DMRS symbols 875-1, 875-2, . . . , etc., within the second slot 860, but with both portions 864a, 864b within the same slot 860 and the same pre-compensation segment 894.

The portion of the second OCC symbol set 816 spread symbols for each UE that is within the first pre-compensation segment 892 is compensated with different compensation parameters than the portion of second OCC symbol set 816 spread symbols for each UE that is within the second pre-compensation segment 894, and orthogonality of the data symbols of OCC symbol set 816 can be lost.

One DMRS symbol at the input of each UE's Tx is spread into 4 symbols at each UE, corresponding to one DMRS spread symbol for each slot and pre-compensation segment. For example, a DMRS symbol at the input of UE1 804-1 is spread into the four DMRS symbols 825-1, 875-1, . . . , etc. A DMRS symbol at the input of UE2 804-2 is spread into the four DMRS symbols 825-2, 875-2, . . . , etc. Orthogonality can be broken for the DMRS based on the UEs applying different pre-compensation parameters Pin to each respective one of the four spread DMRS symbols corresponding to a single DMRS symbol at the input of a UE (e.g., where i is the UE index {1, 2, 3, 4} and where n is the pre-compensation segment index {0, 1, 2, 3}).

In the example OCC configuration of FIG. 8, the pre-compensation segment length of 4 ms breaks orthogonality of the DMRS spread symbols for each UE of the M UEs, and further breaks orthogonality of at least a portion of the data symbols (e.g., the data symbols corresponding to OCC symbol sets that are split across two slots/pre-compensation segments, such as the OCC symbol set 816). The application of different compensators to data symbols and/or DMRS symbols that are spread across different slots and segments can break orthogonality by causing phase changes, and may degrade system performance of the NB-IoT system as noted above. Slots 3 and 4 may be similar to slots 1 and 2 (e.g., 810 and 860) shown in FIG. 8, with different compensators causing a loss in orthogonality for data symbols and DMRS symbols that are spread across Slot 3 and Slot 4.

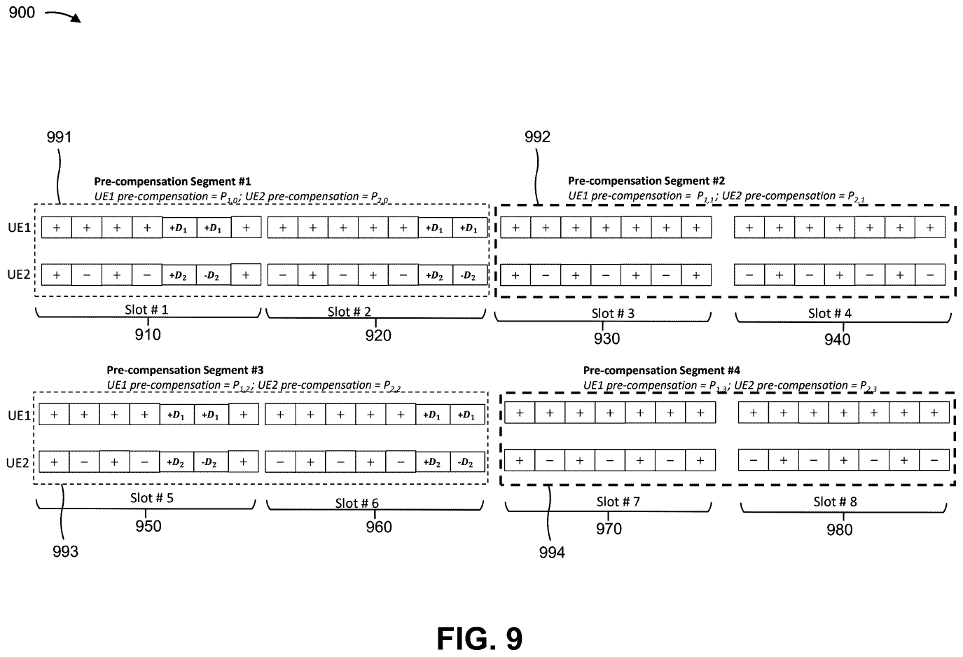

FIG. 9 is a transmission timing diagram 900 illustrating an example of segmented pre-compensation for NTN UL transmissions by multiple UEs configured for OCC multiplexing using a pre-compensation segment length different from a slot length, in accordance with some examples. For example, the transmission timing diagram 900 can correspond to an example NB-IoT system with single tone NPUSCH and using an OCC configuration with OCC 2 (e.g., multiplexing factor or OCC order M=2) and SCS=3.75 kHz. The OCC configuration for OCC 2 can be implemented using symbol-wise OCC, and for uplink slots including 7 symbols per slot, with a slot duration of 2 ms for the SCS of 3.75 kHz and a symbol duration of 2/7 ms. The UL transmissions from UE1 and UE2 can be configured to include DMRS, corresponding to one or more DMRS symbols in at least some of the slots 1-8 (e.g., a first slot 910, second slot 920, third slot 930, fourth slot 940, fifth slot 950, sixth slot 960, seventh slot 970, eighth slot 980).

In some aspects, the UEs (e.g., UE1, UE2) can be configured for DMRS also using OCC 2. For example, the DMRS symbols transmitted by UE1 and UE2 can be OCC-coded according to an OCC 2 configuration, which can be the same as or different from the OCC 2 configuration used to perform OCC coding of the data symbols within the 8 slots shown for each of UEL and UE2 in the transmission timing diagram 900.

In the example transmission timing diagram 900, the eight slots 910-980 can be configured with a slot length of 2 ms, as in the examples of FIG. 7 and FIG. 8. The pre-compensation segment length can be 4 ms, corresponding to UE1 and UE2 updating and/or recalculating their respective pre-compensation information or parameters P_{i,t} every 4 ms (e.g., every two slots), where i represents the UE index and t represents the segment index. For example, a first pre-compensation segment 991 includes the first slot 910 and the second slot 920, with both slots using the first UE1 pre-compensation parameters P_{1,0} or the first UE2 pre-compensation parameters P_{2,0}. A second pre-compensation segment 992 includes the third slot 930 and the fourth slot 940, with both slots using the second UE1 pre-compensation parameters P_{1,1} or the second UE2 pre-compensation parameters P_{2,1}. A third pre-compensation segment 993 includes the fifth slot 950 and the sixth slot 960, with both slots using the third UE1 pre-compensation parameters P_{1,2} or the third UE2 pre-compensation parameters P_{2,2}. A fourth pre-compensation segment 994 includes the seventh slot 970 and the eighth slot 980, with both slots using the fourth UE1 pre-compensation parameters P_{1,3} or the fourth UE2 pre-compensation parameters P_{2,3}.

Based on a DMRS pattern configured for the UEs (e.g., UE1 and UE2), Slot 1 910 includes the two DMRS symbols+D₁, +D₁ for UE1 and the two DMRS symbols+D₂, −D₂ for UE2. Slot 2 920 includes the two DMRS symbols+D₁, +D₁ for UE1 and the two DMRS symbols+D₂, −D₂ for UE2. The first pre-compensation segment 991 includes two DMRS symbols per slot, for each of UE1 and UE2, for a total of eight DMRS symbols in the first pre-compensation segment 991.

Slot 3 930 and Slot 4 940 include no DMRS symbols, for example according to the configured DMRS pattern used by the UEs UE1 and UE2. The second pre-compensation segment 992 therefore includes no DMRS symbols.

Slot 5 950 includes the two DMRS symbols+D₁, +D₁ for UE1 and the two DMRS symbols+D₂, −D₂ for UE2. Slot 6 960 includes the two DMRS symbols+D₁, +D₁ for UE1 and the two DMRS symbols+D₂, −D₂ for UE2. The third pre-compensation segment 993 includes two DMRS symbols per slot, for each of UE1 and UE2, for a total of eight DMRS symbols in the third pre-compensation segment 993.

Slot 7 970 and Slot 8 980 include no DMRS symbols, for example according to the configured DMRS pattern used by the UEs UE1 and UE2. The fourth pre-compensation segment 994 therefore includes no DMRS symbols.

In some cases, the use of the DMRS pattern with no DMRS symbols for the second and fourth pre-compensation segments 992 and 994, respectively, when combined with the slot length of 2 ms and the pre-compensation segment length of 4 ms, can cause the loss of coherence and channel estimation for the UL transmissions by UE1 and UE2 in the pre-compensation segments without DMRS symbols. For example, in pre-compensation segment 2 992 and pre-compensation segment 4 994, the segment includes zero DMRS symbols, which causes a loss of coherence based on phase resetting every 4 ms. The loss of coherence from phase resetting (e.g., based on the lack of DMRS symbols within the pre-compensation segment) can correspond to an inability for the UEs, NTN network entity, and/or NB-IoT system, etc., to perform channel estimation within these pre-compensation segments 992, 994, etc., that lack DMRS symbols.

For the slot length of 2 ms, and the DMRS pattern configured for the UEs UE1 and UE2 where DMRS symbols are present in two of every four consecutive slots (e.g., DMRS symbols in Slot 1, DMRS symbols in Slot 2, no DMRS symbols in Slot 3, no DMRS symbols in Slot 4, DMRS symbols in Slot 5, DMRS symbols in Slot 6, no DMRS symbols in Slot 7, no DMRS symbols in Slot 8, etc.), the loss of coherence can be mitigated by using a pre-compensation segment length that is twice as long, for example by using a scaled (e.g., updated) pre-compensation segment length=2*4 ms=8 ms. Using the 8 ms pre-compensation segment length, each pre-compensation segment includes DMRS symbols and maintains coherence by mitigating the phase resetting and loss of channel estimation that would otherwise be present when using a pre-compensation segment length that leaves one or more pre-compensation segments without DMRS symbols.

The systems and techniques described herein can be used to mitigate the performance loss in data symbols coded using OCC and compensated using UE pre-compensation over segmented pre-compensation intervals. For example, the systems and techniques can mitigate the performance loss associated with the example orthogonality loss in FIG. 8 based on adjusting the pre-compensation segment length (e.g. duration) to be at least 4 ms, which mitigates the performance loss in data symbols during OCC spreading. The 4 ms segment length would not mitigate performance loss in DMRS, however, which in some aspects may be mitigated by adjusting the pre-compensation segment length to be at least 8 ms during OCC spreading for the set of four UEs corresponding to the OCC4 configuration with multiplexing order (e.g., OCC length) M=4.

In one illustrative example, the systems and techniques can be used to implement OCC with UE pre-compensation for NTN transmission and/or NPUSCH uplink transmission based on scaling the pre-compensation segment length by the multiplexing order (e.g., OCC length) M indicated for the OCC configuration applied by a set of UEs being multiplexed. For example, the loss of orthogonality in the example of FIG. 7 can be remediated by increasing the pre-compensation factor from 2 ms to 4 ms. The loss of orthogonality in the example of FIG. 8 can be remediated by increasing the pre-compensation factor from 2 ms to 8 ms.

In some cases, the pre-compensation factor (e.g., pre-compensation segment length or duration) is at least M multiplied by 2 ms, based on the pre-compensation factor being a selected value from the plurality of candidate values configured by the network for the npusch-TxDuration-r17 parameter as {2 ms, 4 ms, 8 ms, 16 ms, 32 ms, 64 ms, 128 ms, 256 ms}. For example, the scaled pre-compensation factor can be adjusted according to a factor of at least 2·M, in the examples of FIG. 7 and FIG. 8. The pre-compensation factor in the example of FIG. 9 is at least M. 2 ms, further multiplied by an additional factor of 2. In one illustrative example, the systems and techniques implement the scaled pre-compensation factor to be at least M. K. 2 ms. For example, in the examples of FIG. 7 and FIG. 8, K=1, and in the example of FIG. 9, K=2. In one illustrative example, the systems and techniques are configured to maintain the orthogonality in data and DMRS symbols during OCC combined with pre-compensation for NTN or NPUSCH uplink by a UE, and to minimize the performance loss associated with the pre-compensation, based on the systems and techniques scaling the pre-compensation segment time by the OCC length M. In some aspects, the pre-compensation segment time is scaled by the OCC length M and an additional scaling factor given by the scalar K (e.g., K=1, K=2, . . . , etc.). In one illustrative example, the additional scaling factor K can be determined based on a DMRS configuration and/or DMRS pattern implemented by the UE for the one or more OCC-coded DMRS symbols that are included in various uplink slots of the uplink transmission from each UE.

In some aspects, the scaled pre-compensation segment time (e.g., segment time·M·K) can be adjusted based on a threshold, for example using a configured threshold value that sets a maximum value of the scaled pre-compensation segment time. For example, the max threshold can be the same as the largest candidate segment time in the npusch-TxDuration-r17 parameter, which is 256 ms. Various other values may also be used for the max threshold value, larger and/or smaller than 256 ms, etc. In some cases, the maximum scaled pre-compensation segment length is set to the threshold value of 256 ms based on UL gaps introduced by NPRACH transmissions, and/or based on the half-duplex nature of the UL transmissions from the UEs.

Based on scaling a configured duration or value of the pre-compensation segment length by the OCC length (e.g., multiplexing order) M, and in at least some examples, further scaling by the additional scalar factor K=1 or K=2, the pre-compensation adjustment can be implemented by the UEs being multiplexed, without network involvement. For example, the UE can receive a normally signaled or configured value for the npusch-TxDuration-r17 parameter, and the UE may then scale the configured value of npusch-TxDuration-r17 by the OCC length M indicated for the current OCC configuration applicable at the UE, and may further apply the additional scaling factor comprising the scalar K=1 or K=2. In some cases, the additional scaling factor or scalar value K can be signaled from the network to the UE, in combined signaling indicative of the OCC configuration and/or OCC length M, or in separate signaling with a first signal(s) indicative of the OCC configuration and/or OCC length M, and a second signal indicative of the additional scaling factor scalar K. In this example, the network is aware when a UE is configured to perform OCC (e.g., based on the network transmitting the OCC configuration to the UE for performing the OCC coding). The network is also aware of the value of M that is configured for the OCC coding, based on the network indicating or assigning the value of the OCC length/multiplexing order M to the UE. The network entity can signal the OCC configuration and the value of M in the same transmission (e.g., a single transmission indicative of the OCC configuration information, etc.), and/or the network entity can indicate the OCC configuration information and the value of M in separate transmission to the UEs. The network entity can signal the value of the additional scalar factor K in the same transmission as a transmission indicative of the OCC configuration information, OCC length M, etc., and/or the network entity can indicate the value of additional scalar factor K in a separate (e.g., different) transmission from a transmission indicative of the OCC configuration information, OCC length M, etc.

In some aspects, the systems and techniques can configure UEs to interpret the npusch-TxDuration-r17 parameter as an input to calculating a new, UE-derived parameter for the scaled pre-compensation segment length when OCC and NPUSCH are simultaneously applied. For example, the UEs can be configured to determine the scaled pre-compensation segment length duration as:

$$npusch - TxDuration - OCC = min ( npusch - TxDuration - r 17 \cdot M \cdot K , 256 ) ms \qquad Eq . ( 1 )$$

Here, the term npusch-TxDuration-OCC represents the scaled pre-compensation segment length that is implemented for UEs that apply both OCC and NTN or NPUSCH pre-compensation. M represents the OCC length (e.g., multiplexing order, etc.). K represents the additional scalar value, for example with K=1 or K=2, based on a DMRS pattern configured for the UEs, etc. In some examples, the value of K can be a configured value according to the network standard or specification. In some cases, the value of the additional scaling factor K can be determined and/or indicated by the NTN network entity to the UEs, for example using one or more RRC messages or transmissions to the UEs that are indicative of at least the configured value of the additional scaling factor K, and/or using one or more DCI messages or transmissions to the UEs that are indicative of at least the configured value of the additional scaling factor K. In some aspects, the configured value for the additional scaling factor K can be determined based on DMRS bundling requirements, and/or channel coherence requirements, etc., associated with the uplink transmissions between the UEs and the NTN network entity.

In some examples, different OCC lengths may be used and configured for data symbols and DMRS symbols at the UE's Tx. For example, data symbols may be OCC coded according to an OCC_{data} configuration and DMRS symbols may be OCC coded according to an OCC_{DMRS} configuration. When OCC_{data} and OCC_{DMRS} are different configurations with different respective OCC lengths (e.g., M_{data}≠M_{DMRS}), Eq. (1) can be updated to replace the term ‘M’ with ‘max (M_{data}, M_{DMRS})’, as in Eq. (2) below:

$$npusch - TxDuration - OCC = min ( npusch - TxDuration - r 17 \cdot max ( {M}_{data} , {M}_{DMRS} ) \cdot K , 256 ) ms \qquad Eq . ( 2 )$$

In some aspects, scaling the signaled pre-compensation segment length from the network by the configured OCC length M and the additional scalar K (e.g., using the scaled pre-compensation segment length M· additional scalar K· original configured pre-compensation segment length) can cause the UE to scale the pre-compensation segment length more than is needed to prevent loss of orthogonality. For example, the network may indicate a pre-compensation segment length of 128 ms and configure the UE to perform OCC2 (e.g., M=2) with the additional scalar K=1. According to Eq. (1) or (2), the UE calculates the scaled (e.g., updated, new, etc.) pre-compensation segment length as 128 ms·2·1=256 ms. In some example network environments, the increased segment length of 256 ms may be too long for the UE to continue using the same pre-compensation information without performing an update to recalculate the pre-compensation parameters (e.g., for durations longer than the un-scaled segment length of 128 ms and/or for durations between the un-scaled segment length of 128 ms and the example scaled segment length of 256 ms, the relative positioning between the UE and the satellite may have changed beyond a threshold amount where the original or same pre-compensation information would remain applicable). In some aspects, where the compensated parameters (e.g., transmission timing and/or frequency impairment) change beyond a threshold amount within the scaled pre-compensation segment length with duration equal to npusch-TxDuration-r17·M·K, the systems and techniques can be configured to calculate the scaled pre-compensation segment length using a minimum constraint on the segment duration based on OCC length M and/or further based on the additional scalar K (e.g., based on M·K).

For example, the systems and techniques can determine the scaled pre-compensation segment length subject to a 2·M·K ms minimum constraint applied on the scaled pre-compensation segment length. In some examples, the maximum threshold duration (e.g., 256 ms, etc.) may be used in combination with the minimum constraint of 2 MK. For example, the plurality of candidate segment durations for npusch-TxDuration-r17 are all multiples of 2, based on each candidate segment duration being a different power of 2 (e.g., the candidate values {2, 4, 8, 16, 32, 64, 128, 256} are equal to {2¹, 2², 2³, 2⁴, 2⁵, 2⁶, 2⁷, 2⁸}). All of the candidate values for the segment duration indicated by the npusch-TxDuration-r17 parameter that are greater than 2 MK ms are a multiple of 2 MK, for the canonical values of M noted above, and for the values of K=1 or 2.

In one illustrative example, the network can configure UEs with OCC and pre-compensation parameters with at least 2 M and K ms. For example, based on the network knowledge of the OCC length M (e.g., selected and/or configured for the UEs by the network when signaling or providing the corresponding OCC configuration to the UEs, etc.), and the network knowledge that a UE is configured to perform OCC, the network can ensure that the pre-compensation segment length has a duration that is at least the minimum constraint of 2 MK ms long.

The configured value of the OCC length or multiplexing order Mis also known at the UE, based on the OCC configuration and/or based on additional signaling from the network entity that indicates the multiplexing order M for the OCC configuration applied by the UE. In some aspects, the UE can be configured to receive information indicative of a configured pre-compensation segment length. For example, the UE can receive information indicative of a configured value of the npusch-TxDuration-r17 parameter, which may be selected from the plurality of candidate segment durations {2, 4, 8, 16, 32, 64, 128, 256}={2¹, 2², 2³, 2⁴, 2⁵, 2⁶, 2⁷, 2⁸}.

In one illustrative example, the UE can be configured to determine the scaled pre-compensation segment length subject to the minimum constraint threshold by using the configured npusch-TxDuration-r17 parameter to derive an updated (e.g., scaled) pre-compensation segment length for OCC with NPUSCH, given as:

$$npusch - TxDuration - OCC = max ( 2 \cdot M \cdot K , npusch - TxDuration - r 17 ) ms \qquad Eq . ( 3 )$$

In Eq. (3), the term npusch-TxDuration-OCC represents the scaled pre-compensation segment length subject to the minimum constraint of being at least duration 2 MK ms. For example, if the configured pre-compensation segment length is 128 ms and the OCC length M=2 and the additional scalar K=1, applying Eq. (1) or (2) resulted in the UE determining an updated pre-compensation segment length of 2·128.1 ms=256 ms.

Applying Eq. (3) and the minimum constraint of 2 MK segment duration corresponds to the UE calculating the scaled pre-compensation segment length as max (2·2·1,128)=max (4,128)=128 ms. In some aspects, the minimum constraint 2 MK for the scaled pre-compensation segment length can reduce the occurrence of UE overshooting when scaling the segment length to longer or higher values of duration. In the example of FIG. 9, applying the minimum constraint of 2 MK segment duration with K=2 corresponds to the UE calculating the scaled pre-compensation segment length as max (2·2·2, 4)=max (8,4)=8 ms, which remediates the issue of loss of coherence and phase resetting causing loss of channel estimation when otherwise using the configured pre-compensation segment length of 4 ms (e.g., as noted above in the example of the transmission timing diagram 900 of FIG. 9, etc.).

In some aspects, the systems and techniques can implement a new segment duration field in an NPUSCH information element used for configuring one or more aspects associated with NPUSCH transmission by a UE. The new field can indicate the segment duration value updated (e.g., scaled) according to the OCC configuration and OCC length M (e.g., and in some cases, the segment duration value further updated according to the additional scaling factor corresponding to the scalar K=1 or 2), as above in Eqs. (1), (2), and/or (3). In some examples, the segment duration field can be implemented in an NPUSCH-Config-NB information element (IE) associated with configuring NPUSCH for one or more UEs. In one illustrative example, the segment duration field can be appended to the NPUSCH-Config-NB IE as the new field npusch-TxDuration-OCC.

In some examples, the scaled pre-compensation segment duration field (e.g., npusch-TxDuration-OCC) may be present in response to a determination by the network that a particular UE is currently performing OCC, is capable of performing OCC, etc. For example, the network may transmit the NPUSCH-Config-NB IE to include the new segment duration field npusch-TxDuration-OCC for one or more UEs that the network determines are OCC-capable UEs. For one or more additional UEs that the network determines are not OCC-capable UEs, the network can transmit the NPUSCH-Config-NB IE without including the new segment duration field npusch-TxDuration-OCC.

The value of the new segment duration field npusch-TxDuration-OCC can be indicative of a particular pre-compensation segment duration length that is selected to be compatible with OCC and NPUSCH pre-compensation (e.g., a pre-compensation segment length that will not break orthogonality for data symbols and/or DMRS symbols of the UE, etc.). In some aspects, the value of the segment duration field (e.g., the value of npusch-TxDuration-OCC) can be set according to, and/or can be indicative of, any of Eqs. (1), (2), and/or (3) above, etc.

In some aspects, the NPUSCH-Config-NB IE can be extended to include new, separate fields for different OCC order. For example, the NPUSCH-Config-NB IE can include a new segment duration field corresponding to OCC with M=2, can include an additional new segment duration field corresponding to OCC with M=4, etc. In some aspects, for OCC2, the corresponding new segment duration field for M=2 can be implemented as npusch-TxDuration-OCC2, and for OCC4, the corresponding new segment duration field for M=4 can be implemented as npusch-TxDuration-OCC4, etc. Further new segment duration fields can be implemented for different OCC orders of DMRS symbols and data symbols. For example, npusch-TxDuration-OCC2-data, npusch-TxDuration-OCC2-dmrs, npusch-TxDuration-OCC4-data, npusch-TxDuration-OCC4-dmrs, . . . , etc.

In some aspects, the UE may be configured to indicate to the network (e.g., satellite network entity, NTN network entity, various other non-terrestrial network entities, etc.) that the UE supports multiplexing and/or supported OCC-based multiplexing. For example, the UE can indicate to the network whether the UE is an OCC-capable device or a non-OCC-capable device. In some aspects, OCC capability information and/or multiplexing capability information of a UE can be included in the UE capability information signaled from the UE to the network entity. For example, the UE capability for multiplexing and/or OCC may be based at least in part on the phase coherence capabilities associated with the UE. In some cases, the network can configure UEs via RRC, where the RRC indication provides UE-specific details for pre-compensation of NPUSCH with OCC. In some cases, the network can provide pre-compensation information to the UE, which may include ephemeris data for determining the UE pre-compensation parameters for the upcoming (e.g., future, scheduled, etc.) uplink transmission to the satellite or NTN network entity associated with the ephemeris data. In some aspects, the network can provide the UE with configuration information indicative of the OCC configuration to be applied for multiplexing at the UE. The OCC configuration and/or OCC configuration information can be indicative of an OCC length (e.g., value of M), can be indicative of an OCC codeword (e.g., a row or column of a Hadamard matrix used for the OCC coding, such as the M×M Hadamard matrix associated with OCC coding 610 of FIG. 6, as noted above), and/or can be indicative of both the OCC length and the OCC codeword for performing the OCC-based multiplexing by the UE.

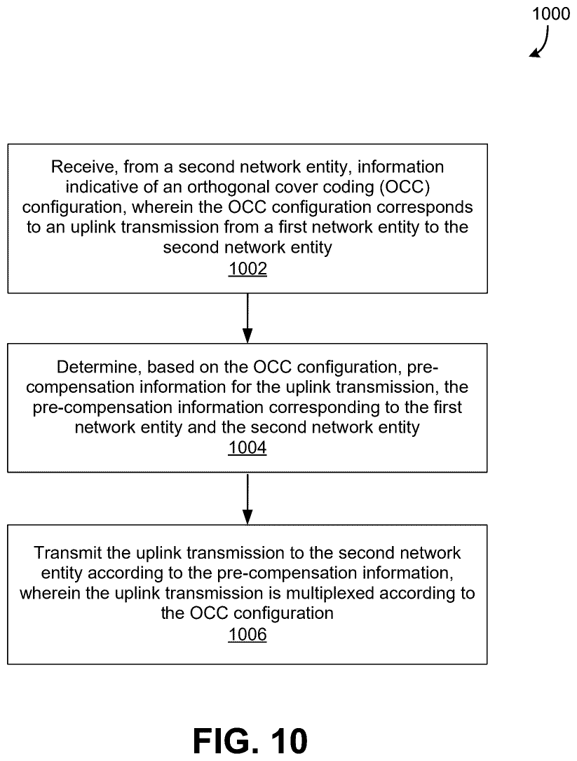

FIG. 10 is a flowchart diagram illustrating an example of a process 1000 for wireless communications. In some aspects, the process 1000 can be a process for wireless communications by a network entity (e.g., a UE, etc.). For example, the process 1000 can be a process for wireless communications by a UE. In some examples, the process 1000 can be performed by a network entity or network device (or apparatus) or a component (e.g., a chipset, codec, etc.) of the network entity or device. The process 1000 can be performed by one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the network entity or device or apparatus. The operations of the process 1000 may be implemented as software components that are executed and run on one or more processors (e.g., processor 1210 and/or processing system 1202 of FIG. 12, or other processor(s)).

In some examples, the process 1000 can be performed by a UE, including any of the UEs of FIGS. 1-8. In some aspects, the process 1000 can be performed by a UE, smartphone, mobile computing device, user computer device, etc. The process 1000 can be performed by a component or system (e.g., a chipset) of a network device (e.g., one or more of UEs 104, 152, 164, 182, 190 of FIG. 1; UE 104 of FIG. 2; UE(s) 104 of FIG. 3; wireless device 407 of FIG. 4; computing system 1200 and/or processing system 1202 of FIG. 12; etc.). The network device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1100 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 1202 of FIG. 12, and/or the processor 1210 of FIG. 12, or other processor(s) (e.g., such as one or more other processors included within and/or associated with the processing system 470 of FIG. 4, the processing system 1202 of FIG. 12, etc.). Further, the transmission and reception of signals by the network entity in the process 1000 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communications interface 1240 of FIG. 12, or other antennae(s), transceiver(s), and/or component(s)).

At block 1002, the network entity (or component thereof) can receive, from a second network entity, information indicative of an orthogonal cover coding (OCC) configuration, wherein the OCC configuration corresponds to an uplink transmission from the first network entity to the second network entity. For example, the network entity can be a UE, corresponding to one or more of the UEs described herein and/or one or more of the UEs of any of FIGS. 1-9, etc. In some examples, the second network entity can be a base station, gNB, etc. For example, the second network entity can be a non-terrestrial network entity of an NTN, etc.

In some cases, the OCC configuration can be associated with performing OCC-based multiplexing of the uplink transmission. The OCC configuration can correspond to the OCC coding 610 of FIG. 6, etc. In some examples, the first network entity is a user equipment (UE). In some cases, the first network entity is a narrowband Internet-of-Things (NB-IoT) device. In some examples, the second network entity is a non-terrestrial network (NTN) network entity. In some examples, the uplink transmission is a narrowband physical uplink shared channel (NPUSCH) transmission. In some cases, the OCC configuration is indicative of an OCC codeword and a multiplexing factor to multiplex the uplink transmission.

At block 1004, the network entity (or component thereof) can determine, based on the OCC configuration, pre-compensation information for the uplink transmission, the pre-compensation information corresponding to the first network entity and the second network entity.

For example, the pre-compensation information can be indicative of a pre-compensation segment length determined based on the OCC configuration. In some cases, the pre-compensation segment length can correspond to a pre-compensation segment, such as one or more of the pre-compensation segment 792, 794 of FIG. 7, 892, 894 of FIG. 8, 991, 992, 993, 994 of FIG. 9, etc. In some cases, the pre-compensation segment length can be a particular time duration value determined from a plurality of configured time duration values. For example, the pre-compensation segment length can be determined from the npusch-TxDuration-r17 parameter configured as a selection from SEQUENCE {ENUMERATED {ms2, ms4, ms8, ms16, ms32, ms64, ms128, ms256}}.

In some cases, the pre-compensation segment length is equal to a narrowband physical uplink shared channel (NPUSCH) segment transmission duration configured for the first network entity, and the uplink transmission is an uplink NPUSCH transmission from the first network entity to the second network entity. In some cases, the pre-compensation segment length is a multiple of an OCC length corresponding to the OCC configuration.

In some examples, the pre-compensation information includes a scaled pre-compensation segment duration corresponding to pre-compensation parameters associated with the uplink transmission. The network entity (or component thereof) can be configured to determine the scaled pre-compensation segment duration based on a configured pre-compensation segment duration.

In some cases, to determine the scaled pre-compensation segment duration, the network entity (or component thereof) can receive, from the second network entity, information indicative of the configured pre-compensation segment duration. The network entity (or component thereof) can scale the configured pre-compensation segment duration by a multiplexing order corresponding to the OCC configuration to determine the scaled pre-compensation segment duration.

To scale the configured pre-compensation segment duration, the network entity (or component thereof) can be configured to scale the configured pre-compensation segment duration by the multiplexing order and an additional scaling factor. For example, the additional scaling factor may be based on at least one of: a demodulation reference signal (DMRS) configuration and DMRS bundling information, or channel coherence information associated with the uplink transmission. In some cases, the network entity (or component thereof) can be configured to receive a message including first information indicative of the additional scaling factor. The message can be a radio resource control (RRC) message or downlink control information (DCI).

In some examples, the multiplexing order is indicated by the information indicative of the OCC configuration. In some examples, the OCC configuration includes the multiplexing order. In some cases, the network entity (or component thereof) can be configured to determine the multiplexing order as a maximum between: a first configured multiplexing order associated with a data portion of the uplink transmission, and a second configured multiplexing order associated with a demodulation reference signal (DMRS) portion of the uplink transmission.

In some cases, to determine the pre-compensation information, the network entity (or component thereof) can receive, from the second network entity, narrowband physical uplink shared channel (NPUSCH) transmission configuration information. The network entity (or component thereof) can then determine the pre-compensation information as a configured pre-compensation segment duration indicated by the NPUSCH transmission configuration information.

In some cases, the NPUSCH transmission configuration information includes a particular field indicative of the configured pre-compensation segment duration. In some examples, the particular field includes a time value determined based on a multiplexing order corresponding to the OCC configuration. In some examples, the NPUSCH transmission configuration information is indicative of: a first pre-compensation segment duration configured corresponding to a first multiplexing order, and a second pre-compensation segment duration configured corresponding to a second multiplexing order.

In some cases, the pre-compensation information includes one or more timing compensation parameters determined based on the OCC configuration for the uplink transmission. In some cases, the pre-compensation information includes one or more frequency compensation parameters determined based on the OCC configuration for the uplink transmission.

At block 1006, the network entity (or component thereof) can transmit the uplink transmission to the second network entity according to the pre-compensation information, wherein the uplink transmission is multiplexed according to the OCC configuration.

In some examples, to transmit the uplink transmission according to the pre-compensation information, the network entity (or component thereof) can transmit the uplink transmission during the scaled pre-compensation segment duration using the pre-compensation parameters. In some cases, the scaled pre-compensation segment duration is a minimum between a configured threshold value and a second value comprising the configured pre-compensation segment duration multiplied by a multiplexing order corresponding to the OCC configuration.

In some cases, the second value comprises the configured pre-compensation segment duration multiplied by the multiplexing order and multiplied by an additional scaling factor associated with a demodulation reference signal (DMRS) configuration for the uplink transmission. In some examples, the configured threshold value is a maximum value for narrowband physical uplink shared channel (NPUSCH) segment transmission duration.

In some cases, the pre-compensation information is indicative of a scaled pre-compensation segment duration corresponding to pre-compensation parameters associated with the uplink transmission. To determine the pre-compensation information, the network entity (or component thereof) can receive, from the second network entity, information indicative of a configured pre-compensation segment duration. The network entity (or component thereof) can determine, based on a multiplexing order corresponding to the OCC configuration, a pre-compensation segment duration threshold value. The network entity (or component thereof) can be configured to determine the scaled pre-compensation segment duration for the uplink transmission as a maximum between the configured pre-compensation segment duration and the pre-compensation segment duration threshold value.

In some cases, to transmit the uplink transmission according to the pre-compensation information, the network entity (or component thereof) can transmit the uplink transmission during the scaled pre-compensation segment duration using the pre-compensation parameters. In some cases, the pre-compensation segment duration threshold value is a minimum value for the scaled pre-compensation segment duration. In some cases, the network entity (or component thereof) can be configured to determine the pre-compensation segment duration threshold value by multiplication of the multiplexing order and a scale factor.

In some examples, the scale factor is based on a slot duration corresponding to the uplink transmission. For example, the scale factor can be based on an additional scaling factor associated with a demodulation reference signal (DMRS) configuration for the uplink transmission. In some examples, the network entity (or component thereof) can be configured to receive control signaling from the second network entity indicative of the multiplexing order.

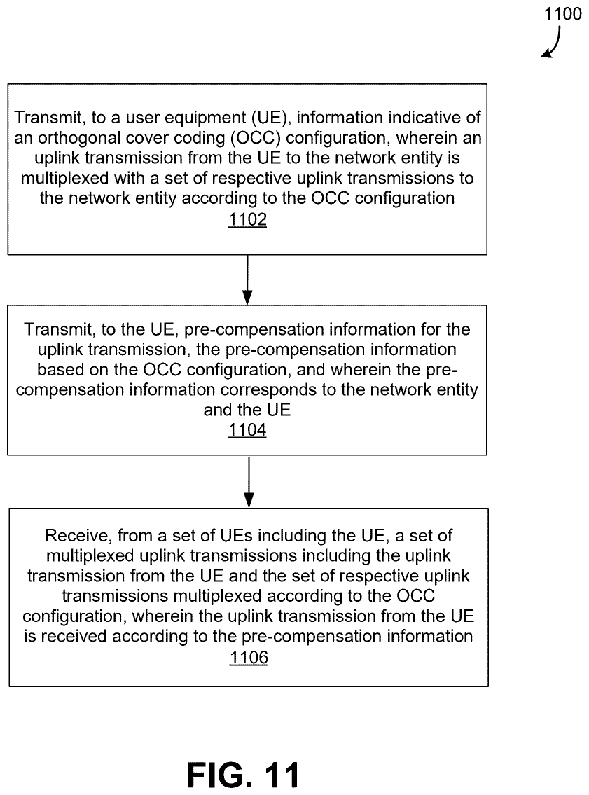

FIG. 11 is a flowchart diagram illustrating an example of a process 1100 for wireless communication. The process 1100 may be performed by a network entity or network device (or apparatus) or a component (e.g., a chipset, codec, etc.) of the network entity or device. The network entity may be a base station (e.g., an eNB, a gNB, etc.) or a portion of a base station (e.g., one or more of a CU, a DU, a RU, a Near-RT RIC, and/or a Non-RT RIC, such as the CU 310, the DU 330, the RU 340, the Near-RT RIC 325, and/or the Non-RT RIC 315 of the disaggregated base station 300 of FIG. 3, etc.), server device, or other network entity. The operations of the process 1100 may be implemented as software components that are executed and run on one or more processors (e.g., the transmit processor 220, the receive processor 238, the TX MIMO processor 230, the MIMO detector 236 of FIG. 2, the processing system 470 of FIG. 4, the processor(s) 484 of FIG. 4, the processing system 1202 of FIG. 12, and/or the processor 1210 of FIG. 12, or other processor(s) (e.g., such as one or more other processors included within and/or associated with the processing system 470 of FIG. 4, the processing system 1202 of FIG. 12, etc.). Further, the transmission and reception of signals by the network entity in the process 1100 may be enabled, for example, by one or more antennas, one or more transceivers (e.g., wireless transceiver(s)), and/or other communication components (e.g., the transmit processor 220, the receive processor 238, the TX MIMO processor 230, the MIMO detector 236, the modulator(s)/demodulator(s) 232a through 232t, and/or the antenna(es) 234a through 234t of FIG. 2, the communications interface 1240 of FIG. 12, or other antennae(s), transceiver(s), and/or component(s)).

At block 1102, the network entity (or component thereof) can transmit, to a user equipment (UE), information indicative of an orthogonal cover coding (OCC) configuration, wherein an uplink transmission from the UE to the network entity is multiplexed with a set of respective uplink transmissions to the network entity according to the OCC configuration.

For example, the network entity can transmit the information to a UE configured to perform the process 1000 of FIG. 10. In some cases, the information indicative of the OCC configuration can be the same as the information of block 1002 of the process 1000 of FIG. 10. The OCC configuration can be the same as the OCC configuration of block 1002 of the process 1000 of FIG. 10.

At block 1104, the network entity (or component thereof) can transmit, to the UE, pre-compensation information for the uplink transmission, the pre-compensation information based on the OCC configuration, and wherein the pre-compensation information corresponds to the network entity and the UE.

For example, the pre-compensation information transmitted at block 1104 can be the same as or similar to the pre-compensation information of block 1004 of the process 1000 of FIG. 10.

At block 1106, the network entity (or component thereof) can receive, from a set of UEs including the UE, a set of multiplexed uplink transmissions including the uplink transmission from the UE and the set of respective uplink transmissions multiplexed according to the OCC configuration, wherein the uplink transmission from the UE is received according to the pre-compensation information.

For example, the set of multiplexed uplink transmissions can include a respective multiplex transmission from each UE of the set of UEs, where each respective multiplex transmission is based on the OCC configuration implemented by the set of UEs. In some cases, the uplink transmission from the UE can be the same as or similar to the uplink transmission transmitted at block 1006 of the process 1000 of FIG. 10.

In some examples, the processes described herein (e.g., process 1000 and/or process 1100 and/or other process described herein) may be performed by a computing device or apparatus (e.g., a network node such as a UE, base station, a portion of a base station, etc.). For example, as noted above, the process 1000 may be performed by a UE, and the process 1100 may be performed by a network entity (e.g., base station, gNB, etc.) that may be associated with the UE of process 1000. In another example, the process 1000 and/or the process 1100 may be performed by a computing device with the computing system 1200 shown in FIG. 12. For example, a wireless communication device with the computing architecture shown in FIG. 12 may include the components of the UE and/or the network entity (e.g., base station, gNB, etc.) and may implement the operations of FIG. 10 and/or FIG. 11.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes 1000 and/or 1100 are illustrated as logical flow diagrams, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1000 and/or the process 1100 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200 including a processing system 1202, which may be for example any computing device making up internal computing system, a remote computing system, a camera, or any component thereof in which the components of the system are in communication with each other using connection 1205. Connection 1205 may be a physical connection using a bus, or a direct connection into processor 1210 (and/or one or more other processors included within and/or associated with the processing system 1202), such as in a chipset architecture. Connection 1205 may also be a virtual connection, networked connection, or logical connection.

In some aspects, computing system 1200 and/or the processing system 1202 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 1202 includes at least one processing unit (CPU or processor) 1210 and connection 1205 that communicatively couples various system components including system memory 1215, such as read-only memory (ROM) 1220 and random access memory (RAM) 1225 to processor 1210. The processing system 1202 may include a cache 1212 of high-speed memory connected directly with, in close proximity to, or integrated as part of processor 1210 and/or one or more other processors included within and/or associated with the processing system 1202.

Processor 1210 may include any general-purpose processor and a hardware service or software service, such as services 1232, 1234, and 1236 stored in storage device 1230, configured to control processor 1210 and/or one or more other processors included within and/or associated with the processing system 1202, as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, processing system 1202 includes an input device 1245, which may represent any number of input mechanisms, such as a microphone for speech, a touch-sensitive screen for gesture or graphical input, keyboard, mouse, motion input, speech, etc. Processing system 1202 may also include output device 1235, which may be one or more of a number of output mechanisms. In some examples, multimodal systems may enable a user to provide multiple types of input/output to communicate with processing system 1202.

Processing system 1202 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210 and/or one or more other processors included within and/or associated with the processing system 1202, it causes the system to perform a function. In some aspects, a hardware service that performs a particular function may include the software component stored in a computer-readable medium in connection with the necessary hardware components, such as processor 1210 (e.g., and/or one or more other processors included within and/or associated with the processing system 1202), connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some examples the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other examples, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

### Illustrative Aspects of the Disclosure Include:

Aspect 1. A first network entity for wireless communication, comprising: a processing system configured to: receive, from a second network entity, information indicative of an orthogonal cover coding (OCC) configuration, wherein the OCC configuration corresponds to an uplink transmission from the first network entity to the second network entity; determine, based on the OCC configuration, pre-compensation information for the uplink transmission, the pre-compensation information corresponding to the first network entity and the second network entity; and transmit the uplink transmission to the second network entity according to the pre-compensation information, wherein the uplink transmission is multiplexed according to the OCC configuration.

Aspect 2. The first network entity of Aspect 1, wherein the pre-compensation information is indicative of a pre-compensation segment length determined based on the OCC configuration.

Aspect 3. The first network entity of Aspect 2, wherein the pre-compensation segment length is a particular time duration value determined from a plurality of configured time duration values.

Aspect 4. The first network entity of any of Aspects 2 to 3, wherein the pre-compensation segment length is equal to a narrowband physical uplink shared channel (NPUSCH) segment transmission duration configured for the first network entity, and wherein the uplink transmission is an uplink NPUSCH transmission from the first network entity to the second network entity.

Aspect 5. The first network entity of any of Aspects 2 to 4, wherein the pre-compensation segment length is a multiple of an OCC length corresponding to the OCC configuration.

Aspect 6. The first network entity of any of Aspects 1 to 5, wherein the pre-compensation information includes a scaled pre-compensation segment duration corresponding to pre-compensation parameters associated with the uplink transmission, and wherein the processing system is configured to determine the scaled pre-compensation segment duration based on a configured pre-compensation segment duration.

Aspect 7. The first network entity of Aspect 6, wherein, to determine the scaled pre-compensation segment duration, the processing system is configured to: receive, from the second network entity, information indicative of the configured pre-compensation segment duration; and scale the configured pre-compensation segment duration by a multiplexing order corresponding to the OCC configuration to determine the scaled pre-compensation segment duration.

Aspect 8. The first network entity of Aspect 7, wherein, to scale the configured pre-compensation segment duration, the processing system is configured to: scale the configured pre-compensation segment duration by the multiplexing order and an additional scaling factor.

Aspect 9. The first network entity of Aspect 8, wherein the additional scaling factor is based on at least one of: a demodulation reference signal (DMRS) configuration and DMRS bundling information, or channel coherence information associated with the uplink transmission.

Aspect 10. The first network entity of any of Aspects 8 to 9, wherein the processing system is configured to receive a message including first information indicative of the additional scaling factor, wherein the message is a radio resource control (RRC) message or downlink control information (DCI).

Aspect 11. The first network entity of any of Aspects 7 to 10, wherein the multiplexing order is indicated by the information indicative of the OCC configuration.

Aspect 12. The first network entity of any of Aspects 7 to 11, wherein the OCC configuration includes the multiplexing order.

Aspect 13. The first network entity of any of Aspects 7 to 12, wherein the processing system is configured to determine the multiplexing order as a maximum between: a first configured multiplexing order associated with a data portion of the uplink transmission, and a second configured multiplexing order associated with a demodulation reference signal (DMRS) portion of the uplink transmission.

Aspect 14. The first network entity of any of Aspects 6 to 13, wherein, to transmit the uplink transmission according to the pre-compensation information, the processing system is configured to: transmit the uplink transmission during the scaled pre-compensation segment duration using the pre-compensation parameters.

Aspect 15. The first network entity of any of Aspects 6 to 14, wherein the scaled pre-compensation segment duration is a minimum between a configured threshold value and a second value comprising the configured pre-compensation segment duration multiplied by a multiplexing order corresponding to the OCC configuration.

Aspect 16. The first network entity of Aspect 15, wherein the second value comprises the configured pre-compensation segment duration multiplied by the multiplexing order and multiplied by an additional scaling factor associated with a demodulation reference signal (DMRS) configuration for the uplink transmission.

Aspect 17. The first network entity of any of Aspects 15 to 16, wherein the configured threshold value is a maximum value for narrowband physical uplink shared channel (NPUSCH) segment transmission duration.

Aspect 18. The first network entity of any of Aspects 1 to 17, wherein the pre-compensation information is indicative of a scaled pre-compensation segment duration corresponding to pre-compensation parameters associated with the uplink transmission, and wherein, to determine the pre-compensation information, the processing system is configured to: receive, from the second network entity, information indicative of a configured pre-compensation segment duration; determine, based on a multiplexing order corresponding to the OCC configuration, a pre-compensation segment duration threshold value; and determine the scaled pre-compensation segment duration for the uplink transmission as a maximum between the configured pre-compensation segment duration and the pre-compensation segment duration threshold value.

Aspect 19. The first network entity of Aspect 18, wherein, to transmit the uplink transmission according to the pre-compensation information, the processing system is configured to: transmit the uplink transmission during the scaled pre-compensation segment duration using the pre-compensation parameters.

Aspect 20. The first network entity of any of Aspects 18 to 19, wherein the pre-compensation segment duration threshold value is a minimum value for the scaled pre-compensation segment duration.

Aspect 21. The first network entity of any of Aspects 18 to 20, wherein the processing system is configured to determine the pre-compensation segment duration threshold value by multiplication of the multiplexing order and a scale factor.

Aspect 22. The first network entity of Aspect 21, wherein the scale factor is based on a slot duration corresponding to the uplink transmission.

Aspect 23. The first network entity of any of Aspects 21 to 22, wherein the scale factor is based on an additional scaling factor associated with a demodulation reference signal (DMRS) configuration for the uplink transmission.

Aspect 24. The first network entity of any of Aspects 18 to 23, wherein the processing system is configured to receive control signaling from the second network entity indicative of the multiplexing order.

Aspect 25. The first network entity of any of Aspects 1 to 24, wherein, to determine the pre-compensation information, the processing system is configured to: receive, from the second network entity, narrowband physical uplink shared channel (NPUSCH) transmission configuration information; and determine the pre-compensation information as a configured pre-compensation segment duration indicated by the NPUSCH transmission configuration information.

Aspect 26. The first network entity of Aspect 25, wherein the NPUSCH transmission configuration information includes a particular field indicative of the configured pre-compensation segment duration.

Aspect 27. The first network entity of Aspect 26, wherein the particular field includes a time value determined based on a multiplexing order corresponding to the OCC configuration.

Aspect 28. The first network entity of any of Aspects 25 to 27, wherein: the NPUSCH transmission configuration information is indicative of: a first pre-compensation segment duration configured corresponding to a first multiplexing order, and a second pre-compensation segment duration configured corresponding to a second multiplexing order.

Aspect 29. The first network entity of any of Aspects 1 to 28, wherein the pre-compensation information includes one or more timing compensation parameters determined based on the OCC configuration for the uplink transmission.

Aspect 30. The first network entity of any of Aspects 1 to 29, wherein the pre-compensation information includes one or more frequency compensation parameters determined based on the OCC configuration for the uplink transmission.

Aspect 31. The first network entity of any of Aspects 1 to 30, wherein the first network entity is a user equipment (UE).

Aspect 32. The first network entity of any of Aspects 1 to 31, wherein the first network entity is a narrowband Internet-of-Things (NB-IoT) device.

Aspect 33. The first network entity of any of Aspects 1 to 32, wherein the second network entity is a non-terrestrial network (NTN) network entity.

Aspect 34. The first network entity of any of Aspects 1 to 33, wherein the uplink transmission is a narrowband physical uplink shared channel (NPUSCH) transmission.

Aspect 35. The first network entity of any of Aspects 1 to 34, wherein the OCC configuration is indicative of an OCC codeword and a multiplexing factor to multiplex the uplink transmission.

Aspect 36. A method for wireless communication by a first network entity, the method comprising: receiving, from a second network entity, information indicative of an orthogonal cover coding (OCC) configuration, wherein the OCC configuration corresponds to an uplink transmission from the first network entity to the second network entity; determining, based on the OCC configuration, pre-compensation information for the uplink transmission, the pre-compensation information corresponding to the first network entity and the second network entity; and transmitting the uplink transmission to the second network entity according to the pre-compensation information, wherein the uplink transmission is multiplexed according to the OCC configuration.

Aspect 37. The method of Aspect 36, wherein the pre-compensation information is indicative of a pre-compensation segment length determined based on the OCC configuration.

Aspect 38. The method of Aspect 37, wherein the pre-compensation segment length is a particular time duration value determined from a plurality of configured time duration values.

Aspect 39. The method of any of Aspects 37 to 38, wherein the pre-compensation segment length is equal to a narrowband physical uplink shared channel (NPUSCH) segment transmission duration configured for the first network entity, and wherein the uplink transmission is an uplink NPUSCH transmission from the first network entity to the second network entity.

Aspect 40. The method of any of Aspects 37 to 39, wherein the pre-compensation segment length is a multiple of an OCC length corresponding to the OCC configuration.

Aspect 41. The method of any of Aspects 36 to 40, wherein the pre-compensation information includes a scaled pre-compensation segment duration corresponding to pre-compensation parameters associated with the uplink transmission, and wherein the processing system is configured to determine the scaled pre-compensation segment duration based on a configured pre-compensation segment duration.

Aspect 42. The method of Aspect 41, wherein determining the scaled pre-compensation segment duration includes: receiving, from the second network entity, information indicative of the configured pre-compensation segment duration; and scaling the configured pre-compensation segment duration by a multiplexing order corresponding to the OCC configuration to determine the scaled pre-compensation segment duration.

Aspect 43. The method of Aspect 42, wherein scaling the configured pre-compensation segment duration includes: scaling the configured pre-compensation segment duration by the multiplexing order and an additional scaling factor.

Aspect 44. The method of Aspect 43, wherein the additional scaling factor is based on at least one of: a demodulation reference signal (DMRS) configuration and DMRS bundling information, or channel coherence information associated with the uplink transmission.

Aspect 45. The method of any of Aspects 43 to 44, further comprising receiving a message including first information indicative of the additional scaling factor, wherein the message is a radio resource control (RRC) message or downlink control information (DCI).

Aspect 46. The method of any of Aspects 42 to 45, wherein the multiplexing order is indicated by the information indicative of the OCC configuration.

Aspect 47. The method of any of Aspects 42 to 46, wherein the OCC configuration includes the multiplexing order.

Aspect 48. The method of any of Aspects 42 to 47, further comprising determining the multiplexing order as a maximum between: a first configured multiplexing order associated with a data portion of the uplink transmission, and a second configured multiplexing order associated with a demodulation reference signal (DMRS) portion of the uplink transmission.

Aspect 49. The method of any of Aspects 41 to 48, wherein transmitting the uplink transmission according to the pre-compensation information includes: transmitting the uplink transmission during the scaled pre-compensation segment duration using the pre-compensation parameters.

Aspect 50. The method of any of Aspects 41 to 49, wherein the scaled pre-compensation segment duration is a minimum between a configured threshold value and a second value comprising the configured pre-compensation segment duration multiplied by a multiplexing order corresponding to the OCC configuration.

Aspect 51. The method of Aspect 50, wherein the second value comprises the configured pre-compensation segment duration multiplied by the multiplexing order and multiplied by an additional scaling factor associated with a demodulation reference signal (DMRS) configuration for the uplink transmission.

Aspect 52. The method of any of Aspects 50 to 51, wherein the configured threshold value is a maximum value for narrowband physical uplink shared channel (NPUSCH) segment transmission duration.

Aspect 53. The method of any of Aspects 36 to 52, wherein the pre-compensation information is indicative of a scaled pre-compensation segment duration corresponding to pre-compensation parameters associated with the uplink transmission, and wherein determining the pre-compensation information includes: receiving, from the second network entity, information indicative of a configured pre-compensation segment duration; determining, based on a multiplexing order corresponding to the OCC configuration, a pre-compensation segment duration threshold value; and determining the scaled pre-compensation segment duration for the uplink transmission as a maximum between the configured pre-compensation segment duration and the pre-compensation segment duration threshold value.

Aspect 54. The method of Aspect 53, wherein transmitting the uplink transmission according to the pre-compensation information includes: transmitting the uplink transmission during the scaled pre-compensation segment duration using the pre-compensation parameters.

Aspect 55. The method of any of Aspects 53 to 54, wherein the pre-compensation segment duration threshold value is a minimum value for the scaled pre-compensation segment duration.

Aspect 56. The method of any of Aspects 53 to 55, further comprising determining the pre-compensation segment duration threshold value by multiplication of the multiplexing order and a scale factor.

Aspect 57. The method of Aspect 56, wherein the scale factor is based on a slot duration corresponding to the uplink transmission.

Aspect 58. The method of any of Aspects 56 to 57, wherein the scale factor is based on an additional scaling factor associated with a demodulation reference signal (DMRS) configuration for the uplink transmission.

Aspect 59. The method of any of Aspects 53 to 58, further comprising receiving control signaling from the second network entity indicative of the multiplexing order.

Aspect 60. The method of any of Aspects 36 to 59, wherein determining the pre-compensation information includes: receiving, from the second network entity, narrowband physical uplink shared channel (NPUSCH) transmission configuration information; and determining the pre-compensation information as a configured pre-compensation segment duration indicated by the NPUSCH transmission configuration information.

Aspect 61. The method of Aspect 60, wherein the NPUSCH transmission configuration information includes a particular field indicative of the configured pre-compensation segment duration.

Aspect 62. The method of Aspect 61, wherein the particular field includes a time value determined based on a multiplexing order corresponding to the OCC configuration.

Aspect 63. The method of any of Aspects 60 to 62, wherein: the NPUSCH transmission configuration information is indicative of: a first pre-compensation segment duration configured corresponding to a first multiplexing order, and a second pre-compensation segment duration configured corresponding to a second multiplexing order.

Aspect 64. The method of any of Aspects 36 to 63, wherein the pre-compensation information includes one or more timing compensation parameters determined based on the OCC configuration for the uplink transmission.

Aspect 65. The method of any of Aspects 36 to 64, wherein the pre-compensation information includes one or more frequency compensation parameters determined based on the OCC configuration for the uplink transmission.

Aspect 66. The method of any of Aspects 36 to 65, wherein the first network entity is a user equipment (UE).

Aspect 67. The method of any of Aspects 36 to 66, wherein the first network entity is a narrowband Internet-of-Things (NB-IoT) device.

Aspect 68. The method of any of Aspects 36 to 67, wherein the second network entity is a non-terrestrial network (NTN) network entity.

Aspect 69. The method of any of Aspects 36 to 68, wherein the uplink transmission is a narrowband physical uplink shared channel (NPUSCH) transmission.

Aspect 70. The method of any of Aspects 36 to 69, wherein the OCC configuration is indicative of an OCC codeword and a multiplexing factor to multiplex the uplink transmission.

Aspect 71. A network entity for wireless communication, comprising: a processing system configured to: transmit, to a user equipment (UE), information indicative of an orthogonal cover coding (OCC) configuration, wherein an uplink transmission from the UE to the network entity is multiplexed with a set of respective uplink transmissions to the network entity according to the OCC configuration transmit, to the UE, pre-compensation information for the uplink transmission, the pre-compensation information based on the OCC configuration, and wherein the pre-compensation information corresponds to the network entity and the UE; and receive, from a set of UEs including the UE, a set of multiplexed uplink transmissions including the uplink transmission from the UE and the set of respective uplink transmissions multiplexed according to the OCC configuration, wherein the uplink transmission from the UE is received according to the pre-compensation information.

Aspect 72. A non-transitory computer-readable storage medium comprising instructions stored thereon which, when executed by at least one processor, causes the at least one processor to perform operations according to any of Aspects 1 to 35.

Aspect 73. An apparatus for wireless communication comprising one or more means for performing operations according to any of Aspects 1 to 35.

Aspect 74. A first network entity for wireless communication, comprising: a processing system configured to: receive, from a second network entity, information indicative of an orthogonal cover coding (OCC) configuration, wherein the OCC configuration corresponds to an uplink transmission from the first network entity to the second network entity; determine, based on the OCC configuration, pre-compensation information for the uplink transmission, the pre-compensation information corresponding to the first network entity and the second network entity; and transmit the uplink transmission to the second network entity according to the pre-compensation information, wherein the uplink transmission is multiplexed according to the OCC configuration.

Aspect 75. The first network entity of Aspect 74, wherein the pre-compensation information is indicative of a pre-compensation segment length determined based on the OCC configuration.

Aspect 76. The first network entity of Aspect 75, wherein the pre-compensation segment length is a particular time duration value determined from a plurality of configured time duration values.

Aspect 77. The first network entity of any of Aspects 75 to 76, wherein the pre-compensation segment length is equal to a narrowband physical uplink shared channel (NPUSCH) segment transmission duration configured for the first network entity, and wherein the uplink transmission is an uplink NPUSCH transmission from the first network entity to the second network entity.

Aspect 78. The first network entity of any of Aspects 75 to 77, wherein the pre-compensation segment length is a multiple of an OCC length corresponding to the OCC configuration.

Aspect 79. The first network entity of any of Aspects 74 to 78, wherein the pre-compensation information includes a scaled pre-compensation segment duration corresponding to pre-compensation parameters associated with the uplink transmission, and wherein the processing system is configured to determine the scaled pre-compensation segment duration based on a configured pre-compensation segment duration.

Aspect 80. The first network entity of Aspect 79, wherein, to determine the scaled pre-compensation segment duration, the processing system is configured to: receive, from the second network entity, information indicative of the configured pre-compensation segment duration; and scale the configured pre-compensation segment duration by a multiplexing order corresponding to the OCC configuration to determine the scaled pre-compensation segment duration.

Aspect 81. The first network entity of Aspect 80, wherein, to scale the configured pre-compensation segment duration, the processing system is configured to: receive a message including first information indicative of an additional scaling factor, wherein the message is a radio resource control (RRC) message or downlink control information (DCI); and scale the configured pre-compensation segment duration by the multiplexing order and an additional scaling factor.

Aspect 82. The first network entity of any of Aspects 80 to 81, wherein the processing system is configured to determine the multiplexing order as a maximum between: a first configured multiplexing order associated with a data portion of the uplink transmission, and a second configured multiplexing order associated with a demodulation reference signal (DMRS) portion of the uplink transmission.

Aspect 83. The first network entity of any of Aspects 79 to 82, wherein, to transmit the uplink transmission according to the pre-compensation information, the processing system is configured to: transmit the uplink transmission during the scaled pre-compensation segment duration using the pre-compensation parameters.

Aspect 84. The first network entity of any of Aspects 79 to 83, wherein the scaled pre-compensation segment duration is a minimum between a configured threshold value and a second value comprising the configured pre-compensation segment duration multiplied by a multiplexing order corresponding to the OCC configuration.

Aspect 85. The first network entity of any of Aspects 74 to 84, wherein the pre-compensation information is indicative of a scaled pre-compensation segment duration corresponding to pre-compensation parameters associated with the uplink transmission, and wherein, to determine the pre-compensation information, the processing system is configured to: receive, from the second network entity, information indicative of a configured pre-compensation segment duration; determine, based on a multiplexing order corresponding to the OCC configuration, a pre-compensation segment duration threshold value; and determine the scaled pre-compensation segment duration for the uplink transmission as a maximum between the configured pre-compensation segment duration and the pre-compensation segment duration threshold value.

Aspect 86. The first network entity of Aspect 85, wherein the pre-compensation segment duration threshold value is a minimum value for the scaled pre-compensation segment duration.

Aspect 87. The first network entity of any of Aspects 85 to 86, wherein the processing system is configured to determine the pre-compensation segment duration threshold value by multiplication of the multiplexing order and a scale factor, and wherein the scale factor is based on at least one of: a slot duration corresponding to the uplink transmission or an additional scaling factor associated with a demodulation reference signal (DMRS) configuration for the uplink transmission.

Aspect 88. The first network entity of any of Aspects 74 to 87, wherein, to determine the pre-compensation information, the processing system is configured to: receive, from the second network entity, narrowband physical uplink shared channel (NPUSCH) transmission configuration information; and determine the pre-compensation information as a configured pre-compensation segment duration indicated by the NPUSCH transmission configuration information.

Aspect 89. The first network entity of Aspect 88, wherein the NPUSCH transmission configuration information includes a particular field indicative of the configured pre-compensation segment duration, and wherein the particular field includes a time value determined based on a multiplexing order corresponding to the OCC configuration.

Aspect 90. The first network entity of any of Aspects 88 to 89, wherein: the NPUSCH transmission configuration information is indicative of: a first pre-compensation segment duration configured corresponding to a first multiplexing order, and a second pre-compensation segment duration configured corresponding to a second multiplexing order.

Aspect 91. The first network entity of any of Aspects 74 to 90, wherein the first network entity is a user equipment (UE), and wherein the second network entity is a non-terrestrial network (NTN) network entity.

Aspect 92. A method for wireless communication by a first network entity, the method comprising: receiving, from a second network entity, information indicative of an orthogonal cover coding (OCC) configuration, wherein the OCC configuration corresponds to an uplink transmission from the first network entity to the second network entity; determining, based on the OCC configuration, pre-compensation information for the uplink transmission, the pre-compensation information corresponding to the first network entity and the second network entity; and transmitting the uplink transmission to the second network entity according to the pre-compensation information, wherein the uplink transmission is multiplexed according to the OCC configuration.

Aspect 93. A network entity for wireless communication, comprising: a processing system configured to: transmit, to a user equipment (UE), information indicative of an orthogonal cover coding (OCC) configuration, wherein an uplink transmission from the UE to the network entity is multiplexed with a set of respective uplink transmissions to the network entity according to the OCC configuration; transmit, to the UE, pre-compensation information for the uplink transmission, the pre-compensation information based on the OCC configuration, and wherein the pre-compensation information corresponds to the network entity and the UE; and receive, from a set of UEs including the UE, a set of multiplexed uplink transmissions including the uplink transmission from the UE and the set of respective uplink transmissions multiplexed according to the OCC configuration, wherein the uplink transmission from the UE is received according to the pre-compensation information.

Aspect 94. A non-transitory computer-readable storage medium comprising instructions stored thereon which, when executed by at least one processor, causes the at least one processor to perform operations according to any of Aspects 74 to 91.

Aspect 95. An apparatus for wireless communication comprising one or more means for performing operations according to any of Aspects 74 to 91.

What is claimed is:

1. A first network entity for wireless communication, comprising:
a processing system configured to:
receive, from a second network entity, information indicative of an orthogonal cover coding (OCC) configuration, wherein the OCC configuration corresponds to an uplink transmission from the first network entity to the second network entity;
determine, based on the OCC configuration, pre-compensation information for the uplink transmission, the pre-compensation information corresponding to the first network entity and the second network entity; and
transmit the uplink transmission to the second network entity according to the pre-compensation information, wherein the uplink transmission is multiplexed according to the OCC configuration.

2. The first network entity of claim 1, wherein the pre-compensation information is indicative of a pre-compensation segment length determined based on the OCC configuration.

3. The first network entity of claim 2, wherein the pre-compensation segment length is a particular time duration value determined from a plurality of configured time duration values.

4. The first network entity of claim 2, wherein the pre-compensation segment length is equal to a narrowband physical uplink shared channel (NPUSCH) segment transmission duration configured for the first network entity, and wherein the uplink transmission is an uplink NPUSCH transmission from the first network entity to the second network entity.

5. The first network entity of claim 2, wherein the pre-compensation segment length is a multiple of an OCC length corresponding to the OCC configuration.

6. The first network entity of claim 1, wherein the pre-compensation information includes a scaled pre-compensation segment duration corresponding to pre-compensation parameters associated with the uplink transmission, and wherein the processing system is configured to determine the scaled pre-compensation segment duration based on a configured pre-compensation segment duration.

7. The first network entity of claim 6, wherein, to determine the scaled pre-compensation segment duration, the processing system is configured to:
receive, from the second network entity, information indicative of the configured pre-compensation segment duration; and
scale the configured pre-compensation segment duration by a multiplexing order corresponding to the OCC configuration to determine the scaled pre-compensation segment duration.

8. The first network entity of claim 7, wherein, to scale the configured pre-compensation segment duration, the processing system is configured to:
receive a message including first information indicative of an additional scaling factor, wherein the message is a radio resource control (RRC) message or downlink control information (DCI); and
scale the configured pre-compensation segment duration by the multiplexing order and an additional scaling factor.

9. The first network entity of claim 7, wherein the processing system is configured to determine the multiplexing order as a maximum between: a first configured multiplexing order associated with a data portion of the uplink transmission, and a second configured multiplexing order associated with a demodulation reference signal (DMRS) portion of the uplink transmission.

10. The first network entity of claim 6, wherein, to transmit the uplink transmission according to the pre-compensation information, the processing system is configured to:
transmit the uplink transmission during the scaled pre-compensation segment duration using the pre-compensation parameters.

11. The first network entity of claim 6, wherein the scaled pre-compensation segment duration is a minimum between a configured threshold value and a second value comprising the configured pre-compensation segment duration multiplied by a multiplexing order corresponding to the OCC configuration.

12. The first network entity of claim 1, wherein the pre-compensation information is indicative of a scaled pre-compensation segment duration corresponding to pre-compensation parameters associated with the uplink transmission, and wherein, to determine the pre-compensation information, the processing system is configured to:
receive, from the second network entity, information indicative of a configured pre-compensation segment duration;
determine, based on a multiplexing order corresponding to the OCC configuration, a pre-compensation segment duration threshold value; and
determine the scaled pre-compensation segment duration for the uplink transmission as a maximum between the configured pre-compensation segment duration and the pre-compensation segment duration threshold value.

13. The first network entity of claim 12, wherein the pre-compensation segment duration threshold value is a minimum value for the scaled pre-compensation segment duration.

14. The first network entity of claim 12, wherein the processing system is configured to determine the pre-compensation segment duration threshold value by multiplication of the multiplexing order and a scale factor, and wherein the scale factor is based on at least one of: a slot duration corresponding to the uplink transmission or an additional scaling factor associated with a demodulation reference signal (DMRS) configuration for the uplink transmission.

15. The first network entity of claim 1, wherein, to determine the pre-compensation information, the processing system is configured to:
receive, from the second network entity, narrowband physical uplink shared channel (NPUSCH) transmission configuration information; and
determine the pre-compensation information as a configured pre-compensation segment duration indicated by the NPUSCH transmission configuration information.

16. The first network entity of claim 15, wherein the NPUSCH transmission configuration information includes a particular field indicative of the configured pre-compensation segment duration, and wherein the particular field includes a time value determined based on a multiplexing order corresponding to the OCC configuration.

17. The first network entity of claim 15, wherein:
the NPUSCH transmission configuration information is indicative of: a first pre-compensation segment duration configured corresponding to a first multiplexing order, and a second pre-compensation segment duration configured corresponding to a second multiplexing order.

18. The first network entity of claim 1, wherein the first network entity is a user equipment (UE), and wherein the second network entity is a non-terrestrial network (NTN) network entity.

19. A method for wireless communication by a first network entity, the method comprising:
receiving, from a second network entity, information indicative of an orthogonal cover coding (OCC) configuration, wherein the OCC configuration corresponds to an uplink transmission from the first network entity to the second network entity;
determining, based on the OCC configuration, pre-compensation information for the uplink transmission, the pre-compensation information corresponding to the first network entity and the second network entity; and
transmitting the uplink transmission to the second network entity according to the pre-compensation information, wherein the uplink transmission is multiplexed according to the OCC configuration.

20. A network entity for wireless communication, comprising:
a processing system configured to:
transmit, to a user equipment (UE), information indicative of an orthogonal cover coding (OCC) configuration, wherein an uplink transmission from the UE to the network entity is multiplexed with a set of respective uplink transmissions to the network entity according to the OCC configuration;
transmit, to the UE, pre-compensation information for the uplink transmission, the pre-compensation information based on the OCC configuration, and wherein the pre-compensation information corresponds to the network entity and the UE; and
receive, from a set of UEs including the UE, a set of multiplexed uplink transmissions including the uplink transmission from the UE and the set of respective uplink transmissions multiplexed according to the OCC configuration, wherein the uplink transmission from the UE is received according to the pre-compensation information.
